(19) United States
(12) Patent Application Publication
(10) Pub. No.: US 2026/0066183 A1
(43) Pub. Date: Mar. 5, 2026

(54) COIL COMPONENT, METHOD FOR MANUFACTURING COIL COMPONENT, AND ELECTRONIC/ELECTRIC DEVICE

(71) Applicant: DELTA ELECTRONICS (JAPAN), INC., Tokyo (JP)

(72) Inventors: Masumi SHIRAISHI, TOKYO (JP); Toru TAKAHASHI, TOKYO (JP); Miyuki SATO, TOKYO (JP); Naoki SAKAZUME, TOKYO (JP); Kenji HASHIZAKI, TOKYO (JP)

(73) Assignee: DELTA ELECTRONICS (JAPAN), INC., Tokyo (JP)

(21) Appl. No.: 19/380,984

(22) Filed: Nov. 6, 2025

Related U.S. Application Data
(63) Continuation of application No. PCT/JP2023/017341, filed on May 8, 2023.

(51) Int. Cl. H01F 27/28; H01F 27/255; H01F 27/29; H01F 41/04

(52) U.S. Cl. CPC H01F 27/2871; H01F 27/255; H01F 27/29; H01F 41/041

(57) ABSTRACT

A coil component having a high degree of design freedom in coil shape and exhibiting minimal quality variation includes a coil portion having a coil conductor portion that includes a first spiral conductor portion having a spiral shape when viewed in a first direction. The coil conductor portion includes a first conductor portion extending from one end to another end of the first spiral conductor portion along the spiral direction and is formed of a first conductive material, and a second conductor portion electrically connected to the first conductor portion at a first interface along the first direction and is formed of a second conductive material. The second conductor portion includes a filling portion in which the first interface is positioned on both sides in a second direction orthogonal to the first direction.

### CROSS REFERENCE TO RELATED APPLICATIONS

This application is a continuation application of PCT Application No. PCT/JP2023/017341, filed on May 8, 2023. The content of the application is incorporated herein by reference.

### BACKGROUND OF THE INVENTION

### 1. Field of the Invention

The present invention relates to a coil component and a method for manufacturing the same. The present invention also relates to an electronic/electric device, in which the coil component is installed.

### 2. Description of the Related Art

Patent Document 1 discloses a multilayer seed-pattern inductor comprising a magnetic body and an internal coil member. The magnetic body includes a magnetic material. The internal coil member is formed by being embedded in the magnetic body and connecting coil conductors disposed on one side and another side of an insulating substrate. The coil conductors include a seed pattern formed in two or more layers, a surface plating layer covering the seed pattern, and an upper plating layer formed on the top surface of the surface plating layer.

Patent Document 2 discloses a power inductor comprising a body, at least one substrate, at least one coil pattern, and external electrodes. The body includes a metal powder and an insulating material. The at least one substrate is provided within the body. The at least one coil pattern is formed on at least one surface of the substrate. The external electrodes are formed on at least two side surfaces of the body. The coil pattern includes a first plating layer formed on the substrate, and a second plating layer formed to cover the first plating layer, wherein the sidewall of the second plating layer are shaped differently from that of the first plating layer. The sidewall of the first plating layer is etched to have a predetermined taper angle from the outer surface of the substrate. The ratio of the width of the bottom surface to the height of the first plating layer is between 1:1 and 1:2. The ratio of the width of the bottom surface of the first plating layer to that of the second plating layer is between 1:1.2 and 1:2.

### PRIOR ART DOCUMENTS

### Patent Documents

[Patent Document 1] Japanese Patent Publication No. 2016-213443
[Patent Document 2] Japanese Patent Publication No. 2021-103796

### SUMMARY OF THE INVENTION

### Problems to be Solved by the Invention

Like the inductor disclosed in Patent Document 1 and Patent Document 2, by forming the conductor member with a multilayer structure, it is possible to increase the cross-sectional area of the conductor member in a direction normal to the current flow (hereinafter referred to as the “current direction”) when current is applied to the inductor such as a coil component that includes a coil conductor portion. This contributes to reduction in the resistance of the conductor member.

An object of the present invention is to advance the technologies disclosed in Patent Document 1 and Patent Document 2, and another object of the present invention is to provide a coil component with superior properties. A further object of the present invention is to provide a method for manufacturing the coil component, as well as an electronic/electrical device, in which the coil component is mounted.

### Means to Solve the Problems

To address the above issues, the present invention, in one embodiment, provides a coil component comprising a coil member. The coil member includes a coil conductor portion. The coil conductor portion includes a first spiral conductor portion having a spiral shape when viewed in a first direction. The coil conductor portion includes a first conductor portion made of a first conductive material, which extends in the spiral direction from one end part to another end part of the first spiral conductor portion, and a second conductor portion made of a second conductive material, which is electrically connected to the first conductor portion at a first interface along the first direction. The second conductor portion includes a filler member on both sides in a second direction orthogonal to the first direction, where the first interfaces are located.

In the coil component, the filler member may be disposed in a region other than a narrowest section of the first spiral conductor portion, where a turn width is the smallest.

In the coil component, the first conductive material may be formed from an electroplating deposit, and the second conductive material may also be formed from a plating deposit.

In the coil component, the first conductive material may comprise a material containing Cu, and the second conductive material may also comprise a material containing Cu.

The coil component may further include a main body portion, which covers the coil member and contains a magnetic powder; and a pair of external electrodes, which are in contact with the surface of the coil member exposed from the main body portion and are electrically interconnected through the coil member. In this case, the coil conductor portion includes a second spiral conductor portion, a via member, a first lead conductor part, and a second lead conductor part. The second spiral conductor portion has a spiral shape facing the first spiral conductor portion in the first direction. The via member contacts one end part of the first spiral conductor portion and one end part of the second spiral conductor portion, and electrically connects the first spiral conductor portion and the second spiral conductor portion in the first direction. The first lead conductor part contacts another end part of the first spiral conductor portion and one of the pair of external electrodes, and electrically connects the first spiral conductor portion and the one of the pair of external electrodes. The second lead conductor part contacts another end part of the second spiral conductor portion and the other of the pair of external electrodes, and electrically connects the second spiral conductor portion and the other of the pair of external electrodes. The coil member may also include a coil insulator portion in contact with the surface of a part of the coil conductor portion, which is located inside the main body portion in the coil conductor portion.

In the coil component, the first lead conductor part may include a third conductor portion made of the first conductive material and extending from the first conductor portion in the current flow direction, and a fourth conductor portion made of the second conductive material and electrically connected to the third conductor portion at a second interface along the first direction. In this case, the fourth conductor portion may include a lead filler member on both sides in the second direction orthogonal to the first direction, where the second interfaces are located.

In the coil component, a conductive layer may further be provided at an end part of the first conductor portion on the side facing the second spiral conductor portion in the first direction. The conductive layer may be composed of a material containing at least one of Ni and Cr.

In the coil component, the second conductor portion may extend to the end part of the first conductor portion on the side opposite to the side, which faces the second spiral conductor portion, in the first direction. The fourth conductor portion may extend to the end part of the first lead conductor portion on the side opposite to the side, where the second spiral conductor portion is located, in the first direction.

In the coil component, the coil insulator portion may include a first insulator portion disposed between the first spiral conductor portion and the second spiral conductor portion, and may further include a second insulator portion in contact with at least one of a side surface of a turn of the first spiral conductor portion and a side surface of a turn of the second spiral conductor portion. The second insulator portion may include a first connecting part, which connects a part in contact with the side surface of the turn of the first spiral conductor portion and a part in contact with the side surface of the turn of the second spiral conductor portion.

According to another aspect, the present invention provides a method for manufacturing a coil component. The coil component includes a coil component. The coil member includes a coil conductor portion. The coil conductor portion includes a first spiral conductor portion having a spiral shape when viewed in a first direction. The coil conductor portion includes a first conductor portion made of a first conductive material, and a second conductor portion made of a second conductive material. In this manufacturing method, the coil member is manufactured by a process including a pattern-forming step, a first plating step, and a second plating step. In the pattern-forming step, a conductive layer pattern, which has a shape corresponding to the first conductor portion, is formed on a surface of an insulating sheet substrate. In the first plating step, a first conductor portion is formed on the conductive layer pattern by electroplating while applying current to the conductive layer. In the second plating step, a second conductor portion is formed on the surface of the first conductor portion by plating. The second conductor portion formed by the second plating step includes a filler member on both sides in a second direction orthogonal to the first direction, where a first interface is an interface between the first conductor portion and the second conductor portion.

Here, S1 represents the area, as viewed from the first direction, of a part of the first conductor portion located in a first region thereof; L1 represents the length of the first region in the current flow direction; S2 represents the area, as viewed from the first direction, of a part of the second conductor portion located in a second region thereof; and L2 represents the length of the second region in the current flow direction.

In the method for manufacturing a coil component, the conductive layer pattern may be formed in the pattern-forming step such that the filler member is formed in a region other than the narrowest section of the first spiral conductor portion, where the turn width is the smallest.

In the method for manufacturing a coil component, the pattern-forming step may involve forming the conductive layer pattern by disposing an insulating negative pattern, which has an inverted shape of the desired conductive layer pattern, onto the conductive layer. In the first plating step, electroplating may be performed using the negative pattern as a masking material.

In the method for manufacturing a coil component, a stripping step may further be included between the first plating step and the second plating step. In the stripping step, the negative pattern is stripped off and the conductive layer exposed in the first direction is removed. In this case, the second plating step may be carried out under a condition that the insulating layer has been removed.

In the method for manufacturing a coil component, the coil component may further include a main body portion, which covers the coil member and contains a magnetic powder, and a pair of external electrodes, which are in contact with the surface of the coil member exposed from the main body portion and are electrically interconnected through the coil member. Furthermore, the coil conductor portion may further include a first lead conductor part. The first lead conductor part contacts another end part of the first spiral conductor portion and one of the pair of external electrodes, and electrically connects the first spiral conductor portion and the one of the pair of external electrodes. The first lead conductor part may include a third conductor portion made of the first conductive material and extending from the first conductor portion in the current flow direction, and a fourth conductor portion made of the second conductive material and electrically connected to the third conductor portion at a second interface along the first direction. In this case, the conductive layer pattern formed in the pattern-forming step has a shape corresponding to the third conductor portion. The third conductor portion may be integrally formed with the first conductor portion in the first plating step, and the fourth conductor portion may be formed in the second plating step. In this case, the fourth conductor portion may include a lead filler member on both sides in the second direction orthogonal to the first direction, where the second interfaces are located.

In the method for manufacturing a coil component, the coil conductor portion includes a second spiral conductor portion having a spiral-shaped turn and arranged in the first direction alongside the first spiral conductor portion, and a via member in contact with one end part of the first spiral conductor portion and one end part of the second spiral conductor portion, electrically connecting the first spiral conductor portion and the second spiral conductor portion in the first direction. The sheet substrate may include a through hole corresponding to the via member. In this case, in the pattern-forming step, a conductive layer pattern corresponding to the second conductor portion may be formed on a surface of the sheet substrate opposite to a surface, where the conductive layer pattern corresponding to the first conductor portion is formed. In the first plating step, the first conductive material may be provided inside the through hole of the substrate to form the via member, thereby electrically connecting the first spiral conductor portion and second spiral conductor portion.

In the method for manufacturing a coil component, the conductive layer may be formed of a material having an etching property different from that of the first conductive material. As a specific example, a material containing at least one of Ni and Cr may be used. The first conductor portion may be formed of a material containing Cu, and the second conductor portion may also be formed of a material containing Cu.

In the manufacturing method of the above-mentioned coil component, after the second plating step, a removal step may be further included. In the removal step, the region on the sheet substrate, which is enclosed by the inner edge of the first spiral conductor portion when viewed in the first direction, is removed.

In the manufacturing method of the above-mentioned coil component, after at least the second plating step is completed, a coating step may be further included. In the coating step, an insulating material is disposed so as to cover at least a portion of the exposed part of the coil conductor portion.

According to another aspect, the present invention provides an electronic/electric device, in which the coil component is mounted, wherein the coil component is connected to a substrate via a pair of external electrodes. Examples of the electronic/electric device include a power supply unit equipped with a power switching circuit, voltage conversion circuit, smoothing circuit, and/or compact portable communication device. Since the electronic/electric device according to the present invention includes the coil component, it exhibits excellent overall performance as an inductive element.

According to the present invention, the degree of freedom in shaping the conductor portion of the coil can be increased. Furthermore, according to the present invention, since regions, which are effective on magnetic properties, and regions, which are effective on electrical properties can be efficiently formed in the coil component, the direct-current resistance of the coil component can be easily lowered while minimizing adverse effects on inductance of the coil component. Accordingly, a coil component with excellent electrical properties can be provided. When this coil component is mounted in an electronic/electric device, it can enhance the performance of the electronic/electric device and/or contribute to size reduction of the electronic/electric device. The present invention also provides an electronic/electric device, in which the coil component is mounted, and a method for manufacturing the coil component.

### BRIEF DESCRIPTION OF THE DRAWINGS

FIG. 1 is a perspective view conceptually illustrating a shape of a coil component according to an embodiment of the present invention.

FIG. 2 is a diagram illustrating a structure of a coil conductor portion included in the coil component according to an embodiment of the present invention.

FIG. 3 is a plan view in the XY plane illustrating a structure of a first spiral conductor portion included in the coil component according to an embodiment of the present invention.

FIG. 4 is a plan view in the XY plane illustrating a structure of a second spiral conductor portion included in the coil component according to an embodiment of the present invention.

FIG. 5 is a cross-sectional view in the XY plane taken along line A-A′ of FIG. 2.

FIG. 6 is an enlarged partial view of FIG. 5.

FIG. 7 is a cross-sectional view in the FZ plane taken along line C-C′ of FIG. 6.

FIG. 8A is a plan view in the XY plane illustrating a first conductor portion included in the coil component according to an embodiment of the present invention.

FIG. 8B is a plan view in the XY plane illustrating a shape feature of the first conductor portion included in the coil component according to an embodiment of the present invention.

FIG. 8C is a plan view in the XY plane illustrating a shape feature of a first comparative conductor portion included in a coil component having a turn-widened section but lacking a filler portion.

FIG. 9 is a cross-sectional view in the XZ plane illustrating a structure of a coil member included in the coil component according to an embodiment of the present invention.

FIG. 10 is a cross-sectional view in the XZ plane illustrating an example of a coil insulator portion included in the coil component according to an embodiment of the present invention.

FIG. 11 is an enlarged partial view of FIG. 10.

FIG. 12 is a first part of an explanatory scheme illustrating an example of a method for manufacturing a coil component according to an embodiment of the present invention.

FIG. 13 is a second part of an explanatory scheme illustrating an example of a method for manufacturing the coil component according to an embodiment of the present invention.

FIG. 14 is a third part of an explanatory scheme illustrating an example of a method for manufacturing the coil component according to an embodiment of the present invention.

FIG. 15 is a fourth part of an explanatory scheme illustrating an example of a method for manufacturing the coil component according to an embodiment of the present invention.

FIG. 16 is a fifth part of an explanatory scheme illustrating an example of a method for manufacturing the coil component according to an embodiment of the present invention.

FIG. 17 is a sixth part of an explanatory scheme illustrating an example of a method for manufacturing the coil component according to an embodiment of the present invention.

FIG. 18 is a seventh part of an explanatory scheme illustrating an example of a method for manufacturing the coil component according to an embodiment of the present invention.

FIG. 19 is an eighth part of an explanatory scheme illustrating an example of a method for manufacturing the coil component according to an embodiment of the present invention.

FIG. 20 is a ninth part of an explanatory scheme illustrating an example of a method for manufacturing the coil component according to an embodiment of the present invention.

FIG. 21 is a plan view in the XY plane illustrating a first one of other examples of a first conductor portion included in the coil member of the coil component according to an embodiment of the present invention.

FIG. 22 is a plan view in the XY plane illustrating a second one of other examples of a first conductor portion included in the coil member of the coil component according to an embodiment of the present invention.

FIG. 23 is a plan view in the XY plane illustrating a third one of other examples of a first conductor portion included in the coil member of the coil component according to an embodiment of the present invention.

FIG. 24 is a plan view in the XY plane illustrating a fourth one of other examples of a first conductor portion included in the coil member of the coil component according to an embodiment of the present invention.

FIG. 25 is a plan view in the XY plane illustrating a pattern of a conductive layer according to a comparative example.

FIG. 26 is a cross-sectional view in the XZ plane illustrating another example of a coil insulator portion included in the coil component according to an embodiment of the present invention.

### DETAILED DESCRIPTION

Below, embodiments according to the present invention will be described in detail with reference to the drawings.

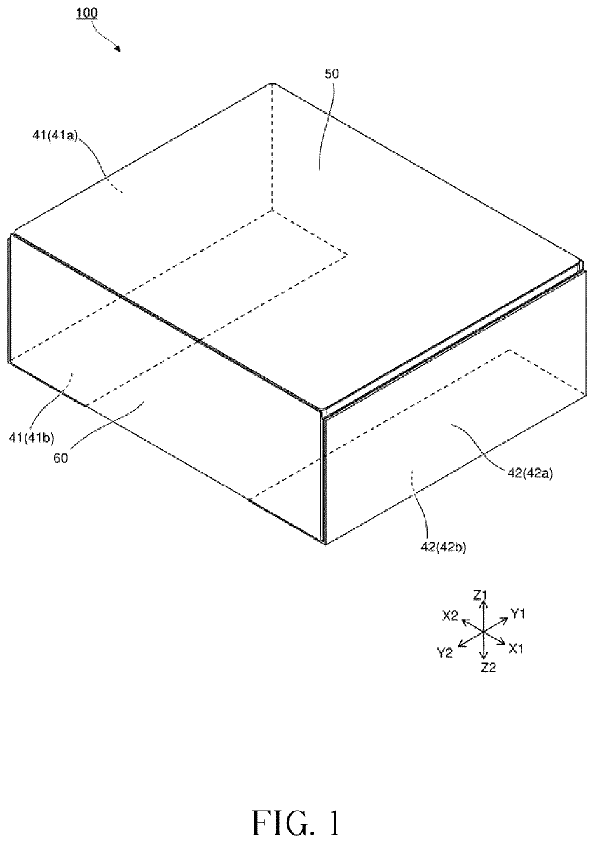

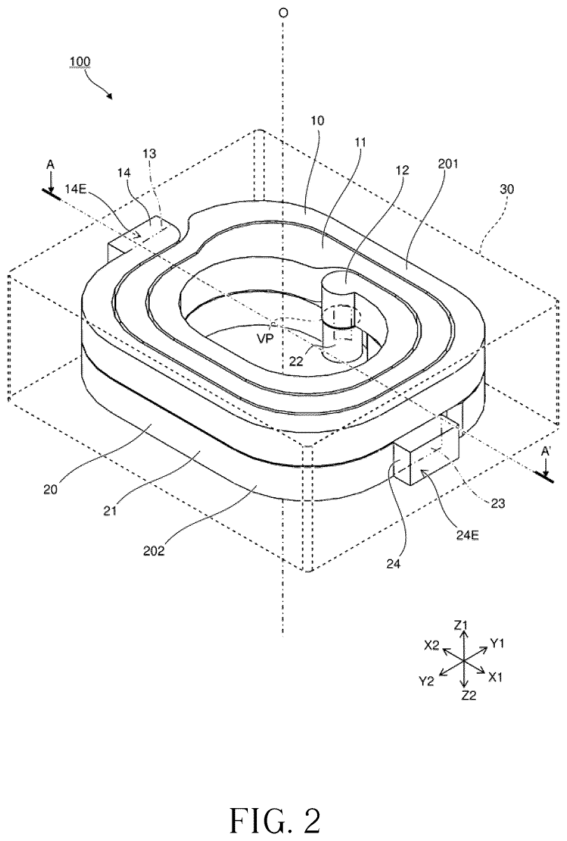

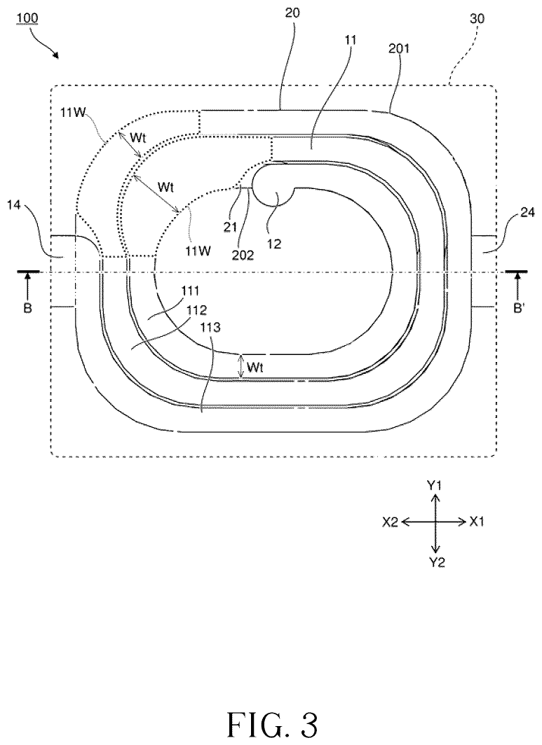

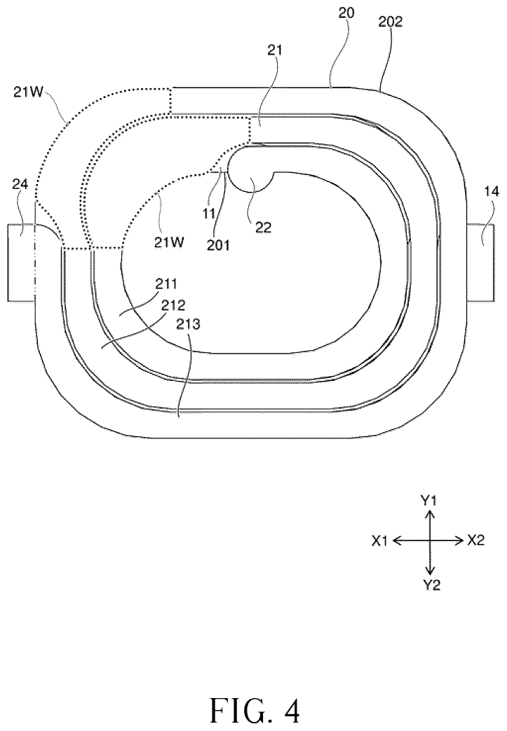

FIG. 1 is a perspective view schematically illustrating a concept of a shape of a coil component according to an embodiment of the present invention. FIG. 2 is a schematic diagram illustrating a structure of a coil conductor portion included in a coil component according to an embodiment of the present invention. In FIG. 2, for ease of explanation, the coil conductor portion is depicted with solid lines, the main body is depicted with dashed lines, and other components are omitted from the drawing. FIG. 3 is an XY plan view illustrating a structure of a first spiral conductor portion included in a coil component according to an embodiment of the present invention. FIG. 4 is an XY plan view illustrating a structure of a second spiral conductor portion included in a coil component according to an embodiment of the present invention. It is to be noted that FIG. 2 is a perspective view seen from the Z1 side in the Z1-Z2 direction, FIG. 3 illustrates only the coil conductor portion as viewed from the Z1 side in the Z1-Z2 direction, and FIG. 4 illustrates only the coil conductor portion as viewed from the Z2 side in the Z1-Z2 direction.

### (Overall Structure)

A coil component 100 according to one embodiment of the present invention includes a coil member 10 having a coil conductor portion 20, a main body portion 30, a first external electrode 41, a second external electrode 42, and outer covers 50 and 60.

### (Coil)

As shown in FIGS. 2 and 3, the coil member 10 includes a coil conductor portion 20 having a first coil conductor portion 201. The first coil conductor portion 201 includes a first spiral conductor portion 11 that is formed in a spiral shape extending around an axis O along a first direction (Z1-Z2 direction), from one end part 12 located on the inner peripheral side toward another end part 13 located on the outer peripheral side, and gradually moves away from the axis O. As shown in FIG. 2, when viewed from the Z1 side in the Z1-Z2 direction, the first spiral conductor portion 11 is arranged in a spiral configuration such that the conductor extends clockwise from the end part 12 toward the end part 13, moving away from the axis O. In the present disclosure, the term “spiral direction” of the spiral portion refers to the direction from the end part on the inner peripheral side toward the end part on the outer peripheral side.

The conductor (conductive material) forming the coil conductor portion 20 is not particularly limited as long as it possesses appropriate electrical conductivity. Specific examples of such conductors include metals such as copper, copper alloys, aluminum, and aluminum alloys. The coil conductor portion 20 may be fabricated using any suitable film-forming technique, such as plating. The coil member 10 further includes a coil insulator portion (not shown in FIGS. 1 to 4) provided on the surface of the coil conductor portion 20. The coil insulator portion ensures electrical insulation between adjacent conductors (i.e., between opposing conductor surfaces) within the coil conductor portion 20. The coil insulator portion may be formed of, for example, a resin material. No coil insulator portion is provided at the terminal ends of the coil conductor portion 20, specifically at the first lead conductor part 14 and the second lead conductor part 24, so that the coil member 10 can be electrically connected to another component at these terminal ends.

Here, when viewed in the first direction (Z1-Z2 direction), the “turn width Wt” is defined as the distance between any arbitrary point on the side surface forming the inner periphery of a turn of the first spiral conductor portion 11 and the point where the normal line (orthogonal to the first direction) from that arbitrary point intersects the side surface forming the outer periphery of the same turn. Under this definition, the first spiral conductor portion 11 includes a turn-widened section 11W, whose turn width Wt is greater than that in other regions. The maximum value of the turn width Wt in the turn-widened section 11W may be, for example, within a range of 1.5 times to 3.0 times the turn width Wt of an adjacent region. Alternatively, the upper limit of this range may be 2.5 times. In FIG. 3, the turn-widened section 11W is indicated as an area enclosed by a dashed line. In the turn-widened section 11W, the relatively large turn width Wt tends to reduce the resistance value. Accordingly, the coil component 100 including the first spiral conductor portion 11 with the turn-widened section 11W tends to exhibit a relatively low direct-current resistance DCR. The definition of the turn width Wt of the first spiral conductor portion 11 also applies to the width of the spiral-shaped turns (e.g., the conductive layer patterns) that appear during the manufacturing process of the first spiral conductor portion 11.

As shown in FIGS. 2 and 4, the coil conductor portion 20 includes a second coil conductor portion 202 having a second spiral conductor portion 21, which is disposed in alignment with the first spiral conductor portion 11 in the first direction. The second spiral conductor portion 21 has a spiral shape extending around an axis O along the first direction (Z1-Z2 direction), from one end part 22 located on the inner peripheral side toward another end part 23 located on the outer peripheral side, and gradually moves away from the axis O. In the second spiral conductor portion 21, when viewed from the Z1 side in the Z1-Z2 direction, the conductor is arranged in a spiral configuration rotating in the opposite direction to the first spiral conductor portion 11 (i.e., counterclockwise in FIG. 2), and moves away from the axis O. Similar to the first spiral conductor portion 11, the second spiral conductor portion 21 also includes a turn-widened section 21W. In FIG. 4, the turn-widened section 21W is illustrated as an area enclosed by a dashed line.

An average distance of gaps between the first spiral conductor portion 11 and the second spiral conductor portion 21 in the first direction (Z1-Z2 direction) is not particularly limited. The decreasing distance of gaps tends to reduce the overall height (dimension in the Z1-Z2 direction) of the coil component 100. However, if the gap distance becomes excessively small, the insulation between the first spiral conductor portion 11 and the second spiral conductor portion 21 may deteriorate. From the perspective of balancing a low-profile coil component 100 with high insulation performance between the first spiral conductor portion and the second spiral conductor portion, it is preferable that the gap distance be within a range of 0.4 μm to 20 μm. More preferably, from a manufacturing standpoint, the gap distance is 1.0 μm or greater to reduce variation in spacing and to ensure stable support of the coil on the same plane. Even more preferably, the gap distance is 5.0 μm or greater.

One end part 12 of the first spiral conductor portion 11 and one end part 22 of the second spiral conductor portion 21 are electrically connected via a via member VP. Starting from the connecting part to the via member VP, the first spiral conductor portion 11 and the second spiral conductor portion 21 being spiral in opposite directions. The via member VP may be formed of the same conductive material as the coil conductor portion 20. In a specific example, the via member VP is formed during the same manufacturing process as the first spiral conductor portion 11 and the second spiral conductor portion 21. In this case, the via member VP is integrally formed with the one end part 12 of the first spiral conductor portion 11 and the one end part 22 of the second spiral conductor portion 21.

At the other end part 13 of the first spiral conductor portion 11, the first lead conductor part 14 is continuously formed as a part of the first coil conductor portion 201. Similarly, at the other end part 23 of the second spiral conductor portion 21, the second lead conductor part 24 is continuously formed as a part of the second coil conductor portion 202. Accordingly, the other end part 13 of the first spiral conductor portion 11 substantially corresponds to the interface with the first lead conductor part 14, and the other end part 23 of the second spiral conductor portion 21 substantially corresponds to the interface with the second lead conductor part 24. In a specific example, the first lead conductor part 14 and the second lead conductor part 24 are also formed during the same manufacturing process as the first spiral conductor portion 11 and the second spiral conductor portion 21. In this case, the first lead conductor part 14 includes a region integrally formed with the other end part 13 of the first spiral conductor portion 11 without a boundary, and the second lead conductor part 24 includes a region integrally formed with the other end part 23 of the second spiral conductor portion 21 without a boundary.

In other words, in the present embodiment, the coil conductor portion 20 includes the first coil conductor portion 201 having the first spiral conductor portion 11 and the first lead conductor portion 14, the second coil conductor portion 202 having the second spiral conductor portion 21 and the second lead conductor portion 24, and the via member VP. These components are manufactured to include integrally formed regions (specifically, regions formed of the first conductive material) through a common manufacturing process.

As shown in FIGS. 3 and 4, respective turns of the first spiral conductor portion 11 and respective turns of the second spiral conductor portion 21 are positioned in alignment along the first direction (Z1-Z2 direction). The first spiral conductor portion 11 includes a first inner peripheral turn 111 located at the innermost periphery, a first outer peripheral turn 113 located at the outermost periphery, and a first central turn 112 located between the inner peripheral turn and the outer peripheral turn. Similarly, the second spiral conductor portion 21 includes a second inner peripheral turn 211 located at the innermost periphery, a second outer peripheral turn 213 located at the outermost periphery, and a second central turn 212 located between the inner turn and the outer peripheral turn.

The second inner peripheral turn 211 is positioned on the Z2 side of the first inner peripheral turn 111 in the Z1-Z2 direction. The second outer peripheral turn 213 is positioned on the Z2 side of the first outer peripheral turn 113 in the Z1-Z2 direction. The second central turn 212 is positioned on the Z2 side of the first central turn 112 in the Z1-Z2 direction. In the coil member 10 shown in FIG. 2, the second lead conductor part 24 is not present on the Z2 side of the other end part 13 of the first spiral conductor portion 11 in the Z1-Z2 direction, and the first lead conductor part 14 is not present on the Z1 side of the other end part 23 of the second spiral conductor portion 21 in the Z1-Z2 direction.

### (First Conductor Portion, Second Conductor Portion)

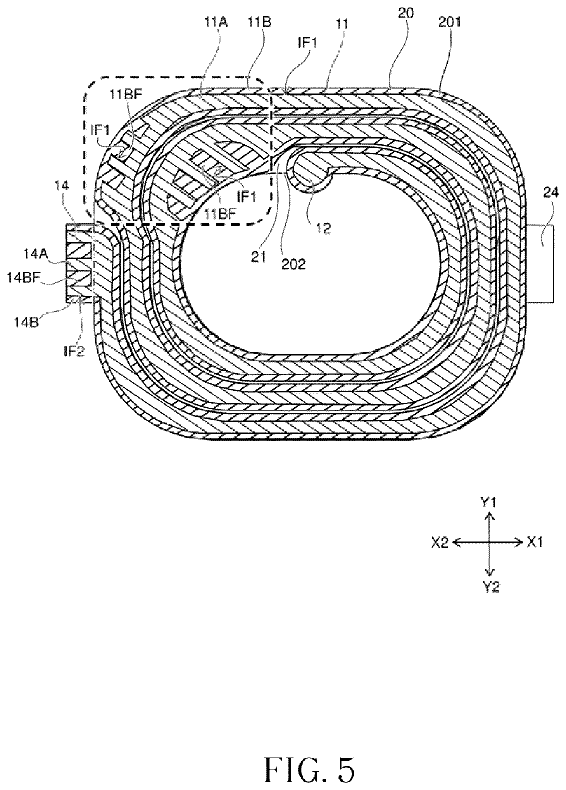

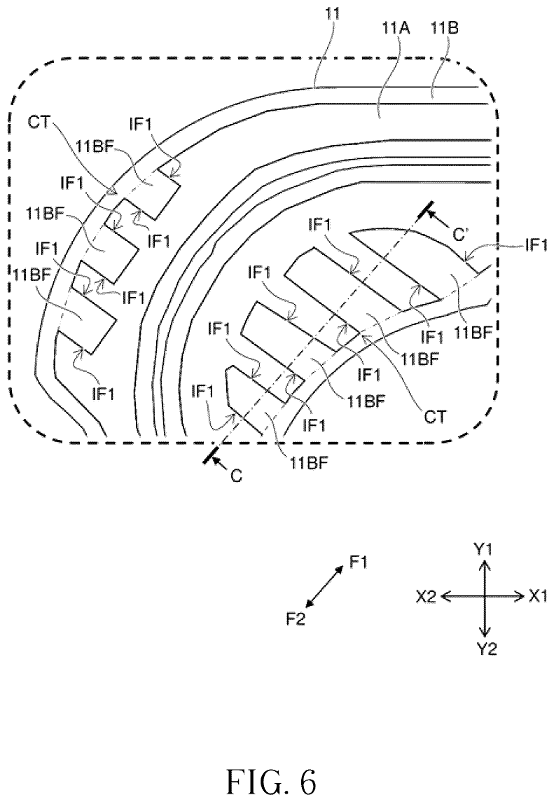

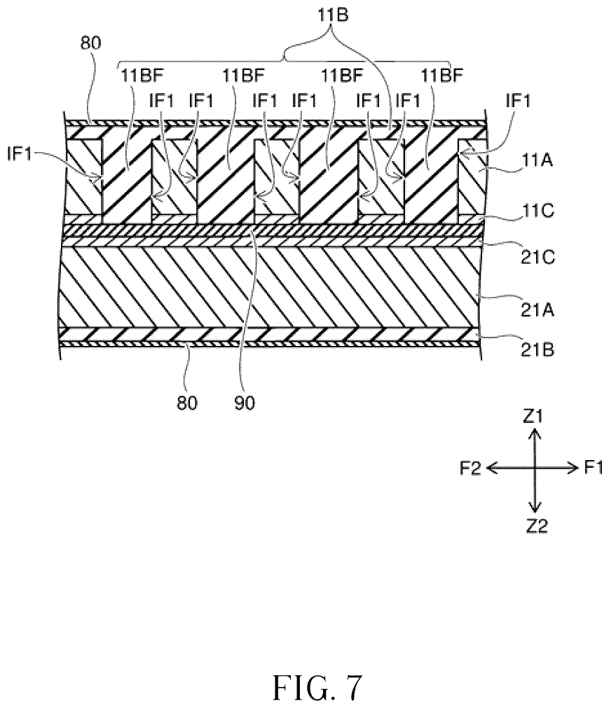

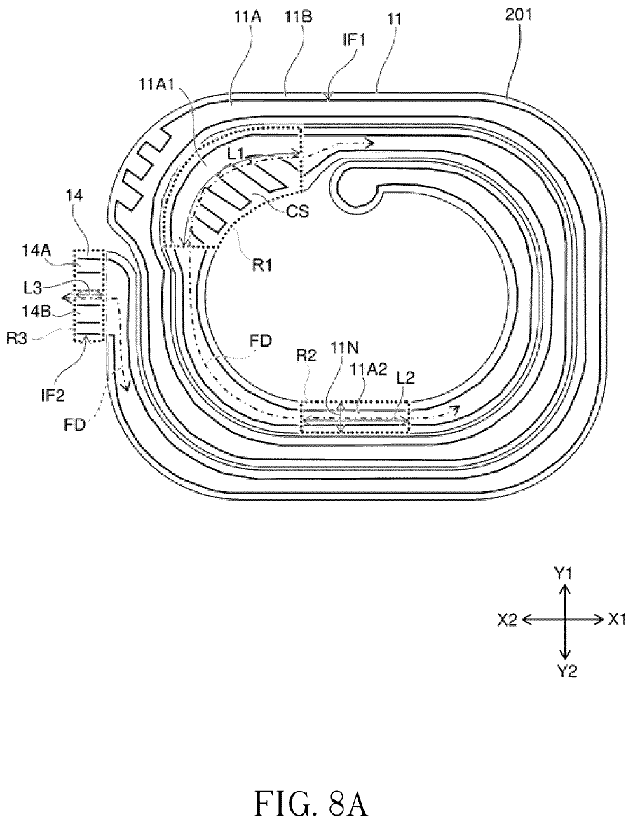

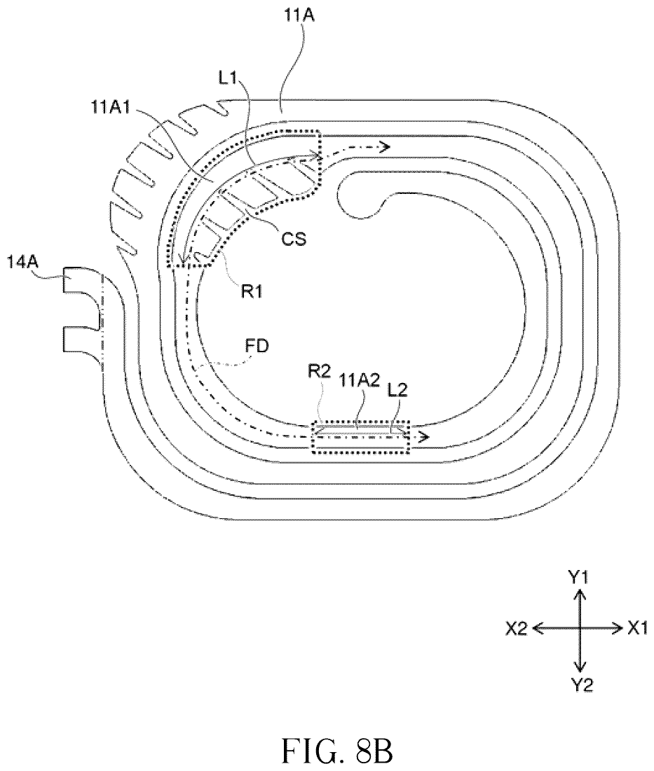

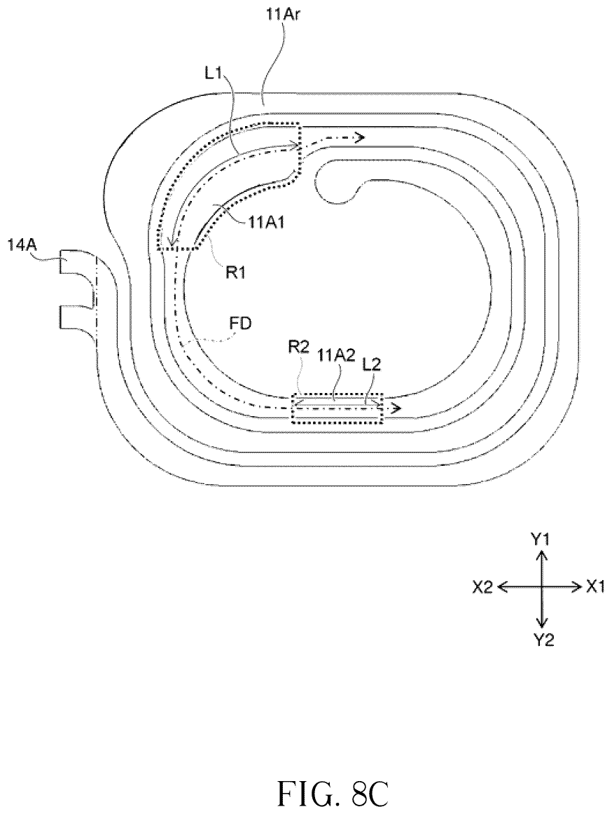

FIG. 5 is an XY cross-sectional view taken along line A-A′ in FIG. 2. FIG. 6 is an enlarged partial view of the region enclosed by dashed lines in FIG. 5. FIG. 7 is an FZ cross-sectional view taken along line C-C′ in FIG. 6. FIG. 8 is an XY plan view illustrating a first conductor portion included in the coil component according to an embodiment of the present invention.

As shown in FIG. 2, line A-A′ passes through the center of the first coil conductor portion 201 in both the Z1-Z2 direction and the Y1-Y2 direction, and extends along the X1-X2 direction. FIG. 5 is a cross-sectional view in the XY plane including this line. As shown in FIG. 5, the first spiral conductor portion 11 includes a first conductor portion 11A, which extends along the spiral direction from one end part 12 to the other end part 13 and is formed of a first conductive material, and a second conductor portion 11B, which is electrically connected to the first conductor portion 11A at a first interface IF1 along the first direction (Z1-Z2 direction) and is formed of a second conductive material. As will be described later, in one example, the first conductor portion 11A and the second conductor portion 11B are manufactured using different fabrication processes. In this case, even if the materials are of the same type (e.g., copper, copper alloys, or other copper-containing materials), they can be distinguished by structural characteristics such as crystal structure, crystal orientation, and crystal growth direction, and can be identified through cross-sectional observation or similar analysis. In a specific example, the first conductor portion 11A is formed from an electroplating deposit (electrolytic plating deposit). The second conductor portion 11B is formed of a plating deposit. The plating deposit may be either an electrolytic plating deposit or an electroless plating deposit. From the perspective of reducing the thickness of the second conductor portion 11B, it is preferable that the plating deposit be an electrolytic plating deposit.

By configuring the first coil conductor portion 201 as a multilayer structure, even if the first conductor portion 11A is subject to design constraints in its XY planar shape due to manufacturing process requirements, such as improving uniformity in formation height, it is still possible to ensure design flexibility in the XY planar shape of the first coil conductor portion 201. This can be achieved by providing a second conductor portion 11B that is electrically connected to the first conductor portion 11A via an appropriate first interface IF1.

A specific example of this configuration is illustrated in FIG. 6. The region shown in the enlarged view of FIG. 6 overlaps with the turn-widened section 11W (see FIG. 3). In this region, the first conductor portion 11A exhibits a comb-tooth shape CT when viewed from the first direction (Z1-Z2 direction), and the second conductor portion 11B is provided to fill the gaps between the comb teeth. The second conductor portion 11B includes members on both sides in the second direction (F1-F2 direction) orthogonal to the first direction, where the first interfaces IF1 are located. The second direction (F1-F2 direction) is one of the directions orthogonal to the first direction and corresponds to the alignment direction of the comb teeth. In the present disclosure, this region is referred to as the filler member 11BF.

FIG. 7 is an FZ cross-sectional view taken along line C-C′ in FIG. 6, which extends in the F1-F2 direction. As shown in FIGS. 6 and 7, the first conductor portion 11A and the second conductor portion 11B are appropriately electrically connected at the first interface IF1, which extends along the first direction (Z1-Z2 direction). Additionally, the second conductor portion 11B located between two adjacent first interfaces IF1 in the second direction (F1-F2 direction) fills the gaps between the comb teeth of the first conductor portion 11A. Therefore, even when current flows in the second direction (F1-F2 direction), the electrical resistance in the region of the first spiral conductor portion 11 shown in FIGS. 6 and 7 remains sufficiently low. As a result, the coil component 100 including the first spiral conductor portion 11 can effectively benefit from the effect of the turn-widened section 11W, namely, the reduction in direct-current resistance DCR. As shown in FIG. 7, in one example, the second conductor portion 11B extends to an end part of the first conductor portion 11A on the side (Z1 side in Z1-Z2 direction) opposite to the side (Z2 side in Z1-Z2 direction) facing the second spiral conductor portion 21 in the first direction (Z1-Z2 direction). In a preferred example, the portion of the first conductor portion 11A extending toward the end part on the Z1 side in the Z1-Z2 direction and the portion of the second conductor portion 11B in contact with the first conductor portion 11A at the first interface IF1 are integrally formed.

At the end part of the first conductor portion 11A on the side facing the second spiral conductor portion 21 in the first direction (Z1-Z2 direction, specifically Z2 side), a conductive layer 11C may be provided, as illustrated in FIG. 7. The material constituting the conductive layer 11C is not limited and may be the same as the material constituting the first conductor portion 11A (for example, a copper-containing material such as Cu or Cu alloy), or may be different. From a manufacturing perspective (as a base layer for electroplating), it may be preferable for the conductive layer 11C to be formed of a material containing at least one of Ni and Cr. It may also be preferable for the material of the conductive layer 11C to have different etching properties from the material of the first conductor portion 11A. For example, when the first conductor portion 11A is formed of Cu and the conductive layer 11C is formed of Ni, it is possible to etch Ni with high selectivity depending on the etching conditions.

In FIG. 7, the second spiral conductor portion 21 is shown as having a laminated structure from the side proximal to the first spiral conductor portion 11, comprising a conductive layer 21C, a first conductor portion 21A, and a second conductor portion 21B. The conductive layer 21C is formed of the same material as the conductive layer 11C, the first conductor portion 21A is formed of the same material as the first conductor portion 11A, and the second conductor portion 21B is formed of the same material as the second conductor portion 11B. Details regarding the coil insulator portions (first insulator portion 90 and second insulator portion 80) will be described later.

The shape of the first conductor portion 11A when viewed from the first direction is further described with reference to FIG. 8A through FIG. 8C. In FIG. 8A, for improved visibility, the boundary between the first conductor portion 11A and the second conductor portion 11B is illustrated with a relatively thick solid line compared to other boundaries.

First, a first region R1, which includes the filler member 11BF but does not include the narrowest section 11N where the turn width Wt of the first spiral conductor portion 11 is the smallest, and a second region R2, which includes the narrowest portion 11N, are defined. In FIG. 8A through FIG. 8C, both the first region R1 and the second region R2 are shown as areas enclosed by dashed lines. In each of the regions, both ends along the current flow direction FD are aligned with the turn width direction. Here, in the first spiral conductor portion 11, the current flow direction FD can be defined as the direction passing through the center of the turn width, and the spiral direction is the direction along the current flow direction FD. The FD direction can be similarly defined for other parts of the coil conductor portion 20, including the first lead conductor part 14, the via member VP, the second spiral conductor portion 21, and the second lead conductor part 24.

In the coil component 100 according to the present embodiment, the rectangular-equivalent width W1 of the first region R1 is greater than the rectangular-equivalent width W2 of the second region R2. Here, the rectangular-equivalent width W1 is obtained by dividing the area ST1 of the first region R1 as viewed from the first direction (Z1-Z2 direction), i.e., the projected area in the first direction, by the length L1 in the current flow direction FD (W1=ST1/L1). Since ST1/L1 represents the length on the other side when the first region R1 is converted into a rectangle with the length on one side denoted as L1, the rectangular-equivalent width W1 indicates the effective width of the first region R1. Similarly, the rectangular-equivalent width W2 is obtained by dividing the area ST2 of the second region R2 as viewed from the first direction (Z1-Z2 direction), i.e., the projected area in the first direction, by the length L2 in the current flow direction FD (W2=ST2/L2). The length L2 of the second region R2 in the current flow direction FD may be, for example, at least 1% of the spiral direction length of the turn in the first spiral conductor portion 11.

As a result of calculation based on the specific shape shown in FIG. 8A, the rectangular-equivalent width W1 is twice the rectangular-equivalent width W2. In this way, by having the relationship of W1>W2, the resistance value of the turn-widened section 11W, which overlaps with the first region R1, is reduced. Therefore, the direct-current resistance DCR of the coil component 100 can be more stably reduced.

The first conductor portion 11A may satisfy the following formula (1):

1.2≤(S1/L1)/(S2/L2)≤5.2 (1)

In the above formula (1), S1 is the area of the portion of the first conductor portion 11A located in the first region R1 (the first portion 11A1), as viewed from the first direction (Z1-Z2 direction), i.e., the projected area in the first direction. Therefore, S1/L1 represents the rectangular-equivalent width of the first portion 11A1. Similarly, S2 is the area of the portion of the first conductor portion 11A located in the second region R2 (the second portion 11A2), as viewed from the first direction (Z1-Z2 direction), i.e., the projected area in the first direction. Therefore, S2/L2 represents the rectangular-equivalent width of the second portion 11A2.

The greater the proximity of the rectangular-equivalent width of the first portion 11A1, which includes the comb-shaped slits CS corresponding to the filler member 11BF, to the rectangular-equivalent width of the second portion 11A2, the greater the tendency for the height uniformity of the first conductor portion 11A to improve when forming the first conductor portion 11A by electroplating (details will be described later). Therefore, by satisfying the above formula (1), the shape design flexibility of the first spiral conductor portion 11 can be enhanced. This means that forming the turn-widened section 11W becomes easier. This contributes to the reduction of the direct-current resistance DCR of the coil component 100. From the perspective of balancing the reduction of direct-current resistance DCR and the height uniformity of the first conductor portion 11A, it is preferable that the lower limit of formula (1) be 1.2 or more, more preferably 1.5 or more. Furthermore, from the perspective of ensuring inductance based on the number of turns in the coil component 100, it is preferable that the upper limit of formula (1) be 5.2 or less, more preferably 5.0 or less, and even more preferably 4.0 or less.

When the first conductor portion 11A having the shape shown in FIG. 8B is formed by electrolytic copper plating and examined in detail, the rectangular-equivalent width (S1/L1) of the first portion 11A1 located in the first region R1, which is obtained by dividing the area S1 of the first portion 11A1 by the length L1 of the first portion 11A1 in the current flow direction FD, is found to be 2.1 times the rectangular-equivalent width (S2/L2) of the second portion 11A2 located in the second region R2, which is obtained by dividing the area S2 of the second portion 11A2 by the length L2 of the second portion 11A2 in the current flow direction FD. On the other hand, the ratio of the average height H1 of the first portion 11A1 to the average height H2 of the second portion 11A2 is approximately 1. In other words, the heights of the first portion 11A1 and the second portion 11A2 are nearly equal.

In contrast, in the first comparative conductor portion 11Ar shown in FIG. 8C, where no comb-shaped slits CS are provided in the first portion 11A1, the value obtained by dividing the rectangular-equivalent width (S1/L1) associated with the first portion 11A1 by the rectangular-equivalent width (S2/L2) associated with the second portion 11A2 is approximately 2.5. The ratio of the average height H1 of the first portion 11A1 to the average height H2 of the second portion 11A2 is approximately 1.5. In this way, by providing a shape corresponding to the filler member 11BF (comb-shaped slits CS) in the first portion 11A1, it is possible to suppress excessive height increase in the first portion 11A1 formed by electroplating compared to other portions. If a locally excessive height occurs in the first conductor portion 11A, the volume of the coil member 10 may increase unexpectedly, resulting in a relative decrease in the volume of the main body portion 30. This may lead to deterioration in the electrical and magnetic properties (such as self-inductance L) of the coil component 100.

Accordingly, since the filler member 11BF is provided for improving the height uniformity of the first conductor portion 11A, it is preferable that the filler member 11BF be located in a section of the first spiral conductor portion 11 other than the narrowest section 11N. Furthermore, from the perspective of suppressing local height increase in the first portion 11A1 when the first conductor portion 11A is formed by electroplating, it is preferable that the first portion 11A1 include a part through which the current flow direction FD does not pass. In other words, it may be preferable that the filler member 11BF be positioned in a part through which the current flow direction FD passes.

### (First Lead Conductor Part)

The first lead conductor part 14 included in the first coil conductor portion 201 of the coil component 100 according to the present embodiment has a multilayer conductor structure similar to that of the first spiral conductor portion 11. Specifically, the first lead conductor part 14 includes a third conductor portion 14A, which is formed of a first conductive material, and extends from the first conductor portion 11A in the current flow direction FD (X2 side in X1-X2 direction, as shown in FIG. 5), and a fourth conductor portion 14B, which is formed of a second conductive material and is electrically connected to the third conductor portion 14A at a second interface IF2 along the first direction (Z1-Z2 direction). The fourth conductor portion 14B includes a lead filler member 14BF, in which the second interface IF2 is located on both sides in the second direction (Y1-Y2 direction in FIG. 5) orthogonal to the first direction (Z1-Z2 direction), where the second interfaces are located. For the first lead conductor part 14, when a third region R3 is defined as a region along the current flow direction FD, which includes the lead filler member 14BF, the rectangular-equivalent width W3 of the third region R3 is obtained by dividing the area ST3 of the third region R3 as viewed from the first direction (Z1-Z2 direction), i.e., the projected area in the first direction, by the length L3 in the current flow direction FD (W3=ST3/L3). The rectangular-equivalent width W3 of the third region R3 is greater than the rectangular-equivalent width W2 of the second region R2. By having such a relationship where W3>W2, the resistance value of the first lead conductor part 14 is reduced. As a result, the direct-current resistance DCR of the coil component 100 can be more stably reduced.

The first lead conductor part 14 may satisfy the following formula (2):

1.2≤(S3/L3)/(S2/L2)≤5.2 (2)

In the above formula (2), S3 is the area of the portion of the third conductor part 14A located in the third region R3 (in FIG. 8A, the entire third conductor portion 14A corresponds to this portion), as viewed from the first direction (Z1-Z2 direction), i.e., the projected area in the first direction. L3 is the length of the third region R3 in the current flow direction FD.

### (Second Coil Conductor Portion)

The above description of the first conductor portion 11A, the second conductor portion 11B, the third conductor portion 14A, and the fourth conductor portion 14B pertains to the first coil conductor portion 201. Nevertheless, in the coil component 100 according to the present embodiment, the second coil conductor portion 202 also has a similar configuration. That is, a first conductor portion 21A formed of a first conductive material extends in the current flow direction FD, and at an end thereof, a third conductor portion 24A forming a part of the second lead conductor part 24 is integrally provided. The second conductor portion 21B formed of a second conductive material is electrically connected to the first conductor portion 21A and includes a filler member 21BF (not shown). The filler member 21BF has a first interface IF1, which is an interface with the first conductor portion 21A, and the first interface IF1 is located on both sides in a direction (XY in-plane direction) orthogonal to the first direction (Z1-Z2 direction. The fourth conductor portion 24B formed of a second conductive material and constituting part of the second lead conductor part 24 is electrically connected to the third conductor portion 24A and includes a lead filler member 24BF (not shown). The lead filler member 24BF has a second interface IF2 (not shown), which is an interface with the third conductor portion 24A, and the second interface IF2 is located on both sides in a direction (XY in-plane direction) orthogonal to the first direction (Z1-Z2 direction. In one example, the second spiral conductor portion 21 includes a conductive layer 21C, and the second lead conductor part 24 includes a conductive layer 24C. Similar to the first spiral conductor portion 11, the second spiral conductor portion 21 includes a turn-widened section 21W, where the turn width Wt is relatively large, and the filler member 21BF is located in the turn-widened section 21W. When the first region R1 through the third region R3 are defined for the second coil conductor portion 202 in the same manner as for the first coil conductor portion 201, it may be preferable that the second coil conductor portion 202 also satisfies the above formula (1) and formula (2).

### (First Insulator Portion)

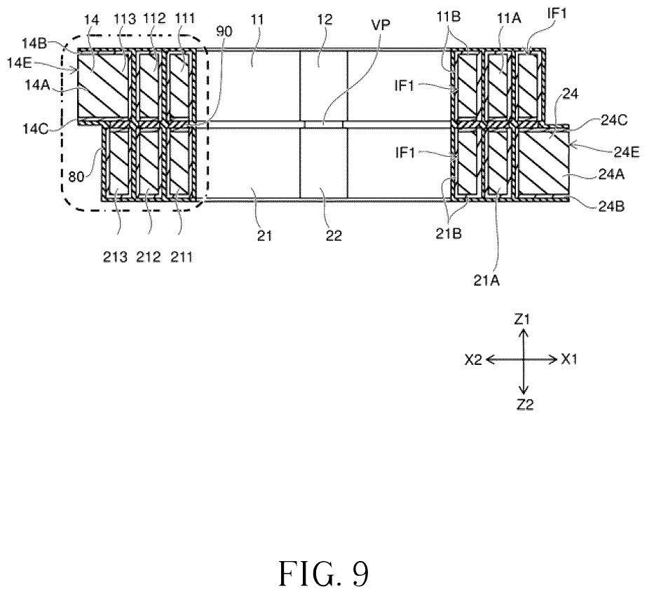

FIG. 9 is an XZ cross-sectional view taken along line B-B′ of FIG. 3, illustrating the structure of a coil member included in a coil component according to an embodiment of the present invention. As shown in FIG. 9, the coil insulator portion includes a first insulator portion 90. The first insulator portion 90 is in contact with at least a part of the end part on one side in the first direction of the first spiral conductor portion 11, specifically, the end part on the side (Z2 side in Z1-Z2 direction) facing the second spiral conductor portion 21. On the side (Z2 side in Z1-Z2 direction) opposite to the side (Z1 side in Z1-Z2 direction) in contact with the first spiral conductor portion 11, the first insulator portion 90 shown in FIG. 9 is in contact with at least a part of the end part on one side in the first direction of the second spiral conductor portion 21, specifically, the end part on the side (Z1 side in the Z1-Z2 direction) facing the first spiral conductor portion 11. In other words, the first insulator portion 90 is interposed between the first spiral conductor portion 11 and the second spiral conductor portion 21 arranged in the first direction, and is in contact with both.

In this manner, by having the first insulator portion 90 contact the first spiral conductor portion 11, reliable insulation of the first spiral conductor portion 11 is achieved. Furthermore, as shown in FIG. 9, the contact of the first insulator portion 90 with both the first spiral conductor portion 11 and the second spiral conductor portion 21 effectively prevents short-circuiting between the two conductor portions in a stable manner.

The material forming the first insulator portion 90 is not particularly limited as long as it possesses appropriate insulating properties. Preferably, the volume resistivity measured in accordance with ASTM D257 is at least 1.0×10¹⁴ Ω·cm. More preferably, the volume resistivity is at least 1.0×10¹⁵ Ω·cm, and even more preferably at least 1.0×10¹⁶ Ω·cm. The upper limit of the volume resistivity is not particularly limited and may be up to 1.0×10²⁰ Ω·cm. Furthermore, it is preferable that the first insulator portion 90 exhibits excellent dielectric properties. Specifically, the relative permittivity at 60 Hz measured in accordance with ASTM D150 is preferably 4.0 or less, more preferably 3.5 or less, and even more preferably 3.0 or less. The upper limit of the relative permittivity is not particularly limited and may be 1.0 or more. The methods for measuring the volume resistivity and relative permittivity of the first insulator portion 90 is not limited as long as they yield results equivalent to those obtained by ASTM D257 and D150. For example, a test specimen may be separately prepared by adjusting the material corresponding to the first insulator portion 90 to the required dimensions, and the constituent material may be identified through analytical techniques such as component analysis or FT-IR, followed by evaluation of properties such as volume resistivity.

The material forming the first insulator portion 90 may be an organic material, an inorganic material, or a composite material comprising an organic material and an inorganic material. In the case of a composite material, the inorganic material may be in a form of particles and dispersed in a matrix formed of the organic material. Examples of the organic material include polyimide resin, polyethylene resin, polypropylene resin, polyamide resin, polyester resin, polyamide-imide resin, polysulfone resin, polycarbonate resin, liquid crystal polymer resin, polyvinylidene fluoride resin, and polytetrafluoroethylene resin. Examples of the inorganic material, particularly for use in the composite material, include oxides, carbides, nitrides, and inorganic salts. Specific examples of the oxides include silica, alumina, and zirconia. Specific examples of the carbides and the nitrides include silicon carbide and boron nitride, respectively. Examples of the inorganic salts include minerals such as wollastonite, kaolin, and mica. Among these, the oxide-based materials such as oxides, silicates, and phosphates are preferred in terms of cost and insulating properties. Preferably, the inorganic material includes at least one selected from the group consisting of silicon (Si), phosphorus (P), boron (B), and calcium (Ca).

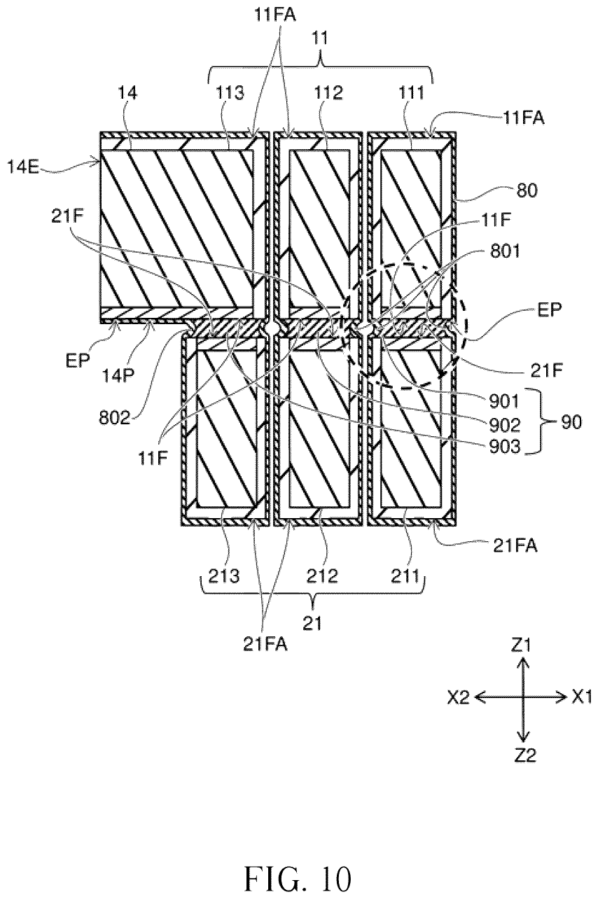

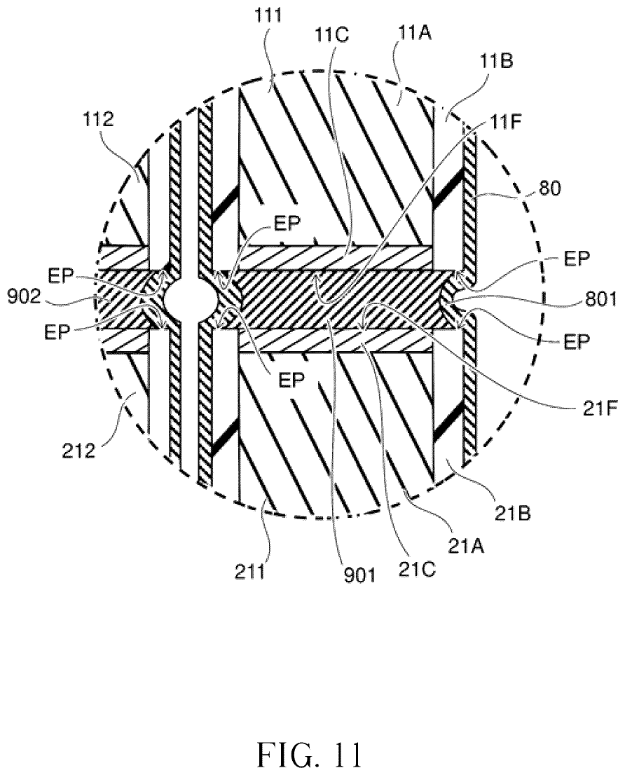

Using FIG. 10, which is an enlarged view of the region enclosed by the dashed line on the X2 side in the X1-X2 direction in FIG. 9, the coil insulator portion included in the coil component 100 will be described in detail. FIG. 10 is an XZ cross-sectional view illustrating an example of the first insulator portion included in the coil component according to an embodiment of the present invention. FIG. 11 is an explanatory diagram of a non-contact portion of the coil conductor portion included in the coil component according to an embodiment of the present invention, and is an enlarged view of the region including the non-contact portion indicated by the dashed circle in FIG. 10.

In one example, in the XZ cross-section as shown in FIG. 10, the first insulator portion 90 is present with three independent portions, including a first insulator portion 901 located between the first inner peripheral turn 111 and the second inner peripheral turn 211, a first insulator portion 902 located between the first central turn 112 and the second central turn 212, and a first insulator portion 903 located between the first outer peripheral turn 113 and the second outer peripheral turn 213. Each of the first insulator portions 901, 902, and 903 has an end positioned further inner in the X1-X2 direction than the end of the turn in contact therewith in the X1-X2 direction, so that a part of the turn is not in contact with the first insulator portion 90.

Specifically, the end of the first insulator portion 901 on the X1 side in the X1-X2 direction is positioned at a further inner side (X2 side in X1-X2 direction) than the end of the first inner peripheral turn 111 on the X1 side in the X1-X2 direction. Therefore, in the portion of the first inner peripheral turn 111 facing the second inner peripheral turn 211 (first facing portion 11F), there exists a portion (non-contact part EP), which is not contact with the first insulator portion 901. Based on the non-contact part EP, as shown in FIG. 9, when viewed in the first direction (Z1-Z2 direction), the envelope of the inner edge of the first insulator portion 90 in contact with the turn forming the inner edge of the first spiral conductor portion 11, i.e., the first inner peripheral turn 111 located at the innermost periphery, encompasses the inner edge of the first spiral conductor portion 11. Similarly, in the portion of the second inner peripheral turn 211 facing the first inner peripheral turn 111 (second facing portion 21F), a non-contact part EP exists on the X1 side in the X1-X2 direction.

Furthermore, since the first insulator portion 902 is independent from the adjacent first insulator portions 901 and 903 in the XZ cross-section, non-contact parts EP exist at both ends in the X1-X2 direction in the portion of the first central turn 112 facing the second central turn 212 (first facing portion 11F), and also at both ends in the portion of the second central turn 212 facing the first central turn 112 (second facing portion 21F). Additionally, since the first insulator portion 903 is independent from the first insulator portion 902 in the XZ cross-section, non-contact parts EP exist at both ends in the X1-X2 direction in the portion of the first outer peripheral turn 113 facing the second outer peripheral turn 213 (first facing portion 11F), and also at both ends in the portion of the second outer peripheral turn 213 facing the first outer peripheral turn 113 (second facing portion 21F). The first insulator portion 90 is not in contact with the end part (first extension part 14P) of the first lead conductor part 14 on the X1 side in the X1-X2 direction, and is also a non-contact part EP.

### (Second Insulator Portion)

The coil insulator portion has a second insulator portion 80. As shown in FIG. 10, the second insulator portion 80 is disposed on at least a portion of the surface of the first coil conductor portion 201 and the surface of the second coil conductor portion 202.

In this embodiment, the second insulator portion 80 is thermoplastic and contains a thermoplastic resin including paraxylyene-based polymer. Other examples of the thermoplastic resin include polyethylene, polypropylene, polyamide, polyester, polyamideimide, polyimide, polysulfone, polycarbonate, liquid crystal polymer, polyvinylidene fluoride, and polytetrafluoroethylene, etc. The second insulator portion 80 is only required to have thermoplastic properties as a whole, and may contain, in addition to the above-mentioned thermoplastic resin, for example, inorganic insulating particles.

It is preferable that the second insulator portion 80 has excellent insulating properties. Specifically, in a case, a volume resistivity of 1.0×10¹⁴ Ωcm or more as measured according to ASTM D257. The volume resistivity is more preferably 1.0×10¹⁵ Ωcm or more, and even more preferably 1.0×10¹⁶ Ωcm or more. The upper limit of the volume resistivity is not specifically limited. The volume resistivity may be 1.0×10²⁰ Ωcm or less. Furthermore, it may be preferable that the second insulator portion 80 has excellent dielectric properties. Specifically, it may be preferable that the relative permittivity at 60 Hz as measured according to ASTM D150 is 4.0 or less. The relative permittivity is more preferable to be 3.5 or less, and even more preferable to be 3.0 or less. The lower limit of the permittivity is not specifically limited. The relative permittivity may be 1.0 or more. For determining the volume resistivity and the relative permittivity, a test sample formed by adjusting a material equivalent to the second insulator portion 80 into a dimension required for determination is alternatively prepared. The material equivalent to the second insulator portion 80, like the case of the first insulator portion 90, for example, can be specified by way of analytical techniques such as component analysis and FT-IR.

The second insulator portion 80 has a portion in contact with a portion of the first spiral conductor portion 11, which is on a side opposite to a side facing the second spiral conductor portion 21, i.e., an opposite portion (first opposite portion 11FA) of the first spiral conductor portion 11 relative to the second spiral conductor portion 21. In FIG. 1, the end parts of the first inner peripheral turn 111, the first central turn 112, and the first outer peripheral turn 113, as well as the end part of the first lead conductor part 14 connected to the first outer peripheral turn 113 on the Z1 side in the Z1-Z2 direction, are the first opposite portion 11FA, and the second insulator portion 80 is disposed on the first opposite portion 11FA.

The second insulator portion 80 has a portion in contact with a portion of the second spiral conductor portion 21, which is an opposite portion (second opposite portion 21FA) of the second spiral conductor portion 21 relative to the first spiral conductor portion 11. In FIG. 10, the end parts of the second inner peripheral turn 211, the second central turn 212, and the second outer peripheral turn 213 on the Z2 side in the Z1-Z2 direction, are the second opposite portion 21FA, and the second insulator portion 80 has a portion connected to the second opposite portion 21FA.

The second insulator portion 80 has a portion in contact with a side portion of the first spiral conductor portion 11 along the spiral direction. If the first inner peripheral turn 111 is used to specifically describe the side portion, in the first inner peripheral turn 111, there are a side portion facing the inner side (X1 side in X1-X2 direction) and a side portion facing the outer side (X2 side in X1-X2 direction) and facing the first central turn 112. The second insulator portion 80 has a portion in contact with these side portions. The second insulator portion 80 is not disposed on the side portion of the another end part 13 of the first spiral conductor portion 11 on the outer side (X2 side of X1-X2 direction) for electrical connection to another member (first external electrode 41).

The second insulator portion 80 has a portion in contact with a side portion of the second spiral conductor portion 21 along the spiral direction. If the second inner peripheral turn 211 is used to specifically describe the side portion, the second inner peripheral turn 211 has a side portion facing the inner side (X1 side in X1-X2 direction) and a side portion facing the outer side (X2 side in X1-X2 direction) and facing the second central turn 212. The second insulator portion 80 has a portion in contact with these side portions. Although not shown in the figure, the second insulator portion 80 is not disposed on the side portion of the another end part 23 of the second spiral conductor portion 21 on the outer side (X2 side of X1-X2 direction) for electrical connection to another member (second external electrode 42).

From the perspective of stable disposition of the second insulator portion 80 on the side portion, it may be preferable that the average width of the gap between two turns aligned in a direction (XY in-plane direction) intersecting the first direction (Z1-Z2 direction) be 0.025 to 0.25 times the average width of the two turns aligned in the alignment direction.

From the perspective of good insulation properties of the second insulator portion 80, it may be preferable that the average value of the thickness of the portion in contact with the first opposite portion 11FA (the portion of the first spiral conductor portion 11 facing the second spiral conductor portion 21), the thickness of the portion in contact with the second opposite portion 21FA (the portion of the second spiral conductor portion 21 facing the first spiral conductor portion 11), the thickness of the portion in contact with the side portion of the first spiral conductor portion 11, and the thickness of the portion in contact with the side portion of the second spiral conductor portion 21 is 0.2 μm or more and 10 μm or less. From the perspective of ensuring more stable insulation properties, the average value is more preferably 1.0 μm or more.

The second insulator portion 80 has a portion in contact with the portion (first facing portion 11F) of the first spiral conductor portion 11 facing the second spiral conductor portion 21, and a portion in contact with the portion (second facing portion 21F) of the second spiral conductor portion 21 facing the first spiral conductor portion 11. As described above, the first facing portion 11F and the second facing portion 21F have non-contact parts EP that is not in contact with the first insulator portion 90. In the non-contact parts EP, the first facing portion 11F and the second facing portion 21F are in contact with the second insulator portion 80.

The second insulator portion 80 has a first linking part 801 disposed to connect a portion in contact with the side portion of a first turn, which is at least one of the turns of the first spiral conductor portion 11 (in this embodiment, the first inner peripheral turn 111, the first central turn 112, and the first outer peripheral turn 113), and a portion in contact with the side portion of a second turn in the second spiral conductor portion 21, which is closest to the side portion of the first turn. The presence of the first linking part 801 facilitates improvement on the insulation properties between the first spiral conductor portion 11 and the second spiral conductor portion 21. From the perspective of stably forming the first linking part 801, it may be preferable that the average value of the distance of the gap in the first direction (Z1-Z2 direction) between the first spiral conductor portion 11 and the second spiral conductor portion 21 be 0.4 μm or more and 20 μm or less.

Taking the case that the first turn is the first inner peripheral turn 111 as a specific example, the second turn, which is the closest to the side portion of the first turn (first inner peripheral turn 111) in the second spiral conductor portion 21, is the second inner peripheral turn 211. The second insulator portion 80, which is in contact with the side portion of the first inner peripheral turn 111 on the inner side (X1 side in X1-X2 direction), is also in contact with the non-contact part EP, where the first insulator portion 90 disposed at the end of the first facing portion 11F on the inner side (X1 side in X1-X2 direction) is not in contact with the first facing portion 11F. On the other hand, the second insulator portion 80, which is in contact with the side portion of the second inner peripheral turn 211 on the inner side (X1 side in X1-X2 direction), is also in contact with the non-contact part EP, where the first insulator portion 90 disposed at the end of the second facing portion 21F on the inner side (X1 side in X1-X2 direction) is not in contact with the second facing portion 21F. The second insulator portion 80, which is disposed in a manner that the second insulator portion 80 in contact with the first inner peripheral turn 111 on the inner side (X1 side in X1-X2 direction) and the second insulator portion 80 in contact with the second inner peripheral turn 211 on the inner side (X1 side in X1-X2 direction) are connected, is the first linking part 801.

In FIG. 10, furthermore, a linking part 801, which connects the second insulator portion 80 in contact with the side portion of the first inner peripheral turn 111 on the outer side (X2 side in X1-X2 direction) and the first facing portion 11F to the second insulator portion 80 in contact with the side portion of the second inner peripheral turn 211 on the outer side (X2 side in X1-X2 direction) and the second facing portion 21F; a linking part 801, which connects the second insulator portion 80 in contact with the side portion of the first central turn 112 on the inner side (X1 side in X1-X2 direction) and the first facing portion 11F to the second insulator portion 80 in contact with the side portion of the second central turn 212 on the inner side (X1 side in X1-X2 direction) and the second facing portion 21F; a linking part 801, which connects the second insulator portion 80 in contact with the side portion of the first central turn 112 on the outer side (X2 side in X1-X2 direction) and the first facing portion 11F to the second insulator portion 80 in contact with the side portion of the second central turn 212 on the outer side (X2 side in X1-X2 direction) and the second facing portion 21F; and a linking part 801, which connects the second insulator portion 80 in contact with the side portion of the first outer peripheral turn 113 on the inner side (X1 side in X1-X2 direction) and the first facing portion 11F to the second insulator portion 80 in contact with the side portion of the second outer peripheral turn 213 on the inner side (X1 side in X1-X2 direction) and the second facing portion 21F, are shown.

In this way, by having the first linking parts 801, the volume of the coil insulation portion can be reduced, making it easier to improve the electrical properties of the coil component 100 and meet the demand for minimization of the coil component 100.

The second insulator portion 80 in contact with the side portion of the second outer peripheral turn 213 on the outer side (X2 side in X1-X2 direction) includes a second linking part 802. The second linking part 802 connects the second insulator portion 80 in contact with the first extension part 14P, which is a part of the first lead conductor part 14 on the Z2 side in the Z1-Z2 direction, and extends from the first facing portion 11F of the first outer peripheral turn 113, to the second insulator portion 80 in contact with the side portion of the second outer peripheral turn 213 on the outer side (X2 side in X1-X2 direction) and the second facing portion 21F.

The second insulator portion 80 shown in FIG. 10 is in contact with a portion disposed inside the main body portion 30 within the coil conductor portion 20. Specifically, in the coil conductor portion 20, for contact with a portion excluding the end portion (first lead conductor end face 14E) of the first lead conductor part 14 on the outer side (X2 side in X1-X2 direction) and the end portion (second lead conductor end face 24E, not shown in FIG. 10) of the second lead conductor part 24 on the outer side (X2 side in X1-X2 direction), the second insulator portion 80 is provided. In this way, even if the surface of the magnetic powder contained in the main body portion 30 is conductive, and the coil conductor portion 20 is in contact with the magnetic powder, the result is that occurrence of unexpected short circuit within the coil conductor portion 20 can be prevented. As will be described later, a first external electrode 41 is disposed to be in electric contact with the first lead conductor end face 14E, and a second external electrode 42 is disposed to be in electric contact with the second lead conductor end face 24E.

From the perspective of stably preventing short circuit within the coil conductor portion 20, it is preferable that the second insulator portion 80 in contact with the first spiral conductor portion 11 includes a portion in contact with the portion facing the second spiral conductor portion 21 (first facing portion 11F), a portion in contact with the portion opposite to the second spiral conductor portion 21 (first opposite portion 11FA), and a portion in contact with the side portion, which are mutually connected without any connection boundary and continuously in contact with the turns for all turns of the first spiral conductor portion 11. Likewise, it is preferable that the second insulator portion 80 in contact with the second spiral conductor portion 21 includes a portion in contact with the portion facing the first spiral conductor portion 11 (second facing portion 21F), a portion in contact with the portion opposite to the second spiral conductor portion 21 (second opposite portion 21FA), and a portion in contact with the side portion, which are mutually connected without any connection boundary and continuously in contact with the turns for all turns of the second spiral conductor portion 21.

### (Main Body Portion)

The main body portion 30 contains a magnetic powder and encompasses a portion of the coil member 10. In this embodiment, the main body portion 30 has a substantially rectangular parallelepiped shape and encloses the coil member 10 except for the outermost (X2 side in X1-X2 direction) end face of the first lead conductor part 14 and the outermost (X1 side in X1-X2 direction) end face of the second lead conductor part 24, which are located at the ends of the coil member 10.

The structure of the magnetic powder is not limited. This structure may include a crystalline phase or an amorphous phase. Herein, a crystalline material is defined as a material formed of a crystalline phase, an amorphous material is defined as a material formed of an amorphous phase, and a composite material is defined as a material including a crystalline material and an amorphous material. In a situation that the diffraction spectrum obtained by a general X-ray diffraction method includes a sharp diffraction peak that can identify the type of crystalline phase, the material includes a crystalline phase. On the other hand, in the situation that the diffraction spectrum obtained by a general X-ray diffraction method includes a broad peak indicating an amorphous phase, the material includes an amorphous phase. If the DSC curve obtained by differential thermal analysis includes a peak indicating crystallization, i.e., heat generation associated with a phase change from an amorphous phase to a crystalline phase, the material includes an amorphous phase.

The material system of the magnetic powder is not limited. Specific examples of the crystalline material include Fe—Si—Cr based alloys, Fe—Ni based alloys, Fe—Co based alloys, Fe—V based alloys, Fe—Al based alloys, Fe—Si based alloys, Fe—Si—Al based alloys, iron only, and ferrite. It is preferable to use carbonyl iron powder as iron-only powder. Specific examples of the amorphous material include Fe—Si—B based alloys, Fe—P—C based alloys, and Co—Fe—Si—B based alloys. Specific examples of composite materials include Fe—Zr based alloys, Fe—Zr—B based alloys, Fe—Si—B—Nb—Cu based alloys, and Fe—Si—B—P—Cu based alloys. If the magnetic powder is metal powder containing Fe, the synergistic effect on improvement of magnetic properties is particularly significant.

The chemical composition of the magnetic powder is not limited. For example, the Fe—Si—Cr based alloy may be composed of 1.0-10.0 mass % Si, 1.0-10.0 mass % Cr, and the remainder composed of Fe and impurities. Also, for example, the Fe—Ni based alloy may be composed of 1.0-99.0 mass % Ni, and the remainder composed of Fe and impurities. Furthermore, for example, the Fe—P—C based alloy may be composed of 1.0-13.0 atom % P, 1.0-13.0 atom % C, Fe, and impurities. The Fe—P—C based alloy may contain one or more optional elements selected from the group consisting of Ni, Sn, Cr, B, and Si. In this case, for example, the amount of Ni may be 0 to 10.0 atomic %, the amount of Sn may be 0 to 3.0 atom %, the amount of Cr may be 0 to 6.0 atom %, the amount of B may be 0 to 9.0 atom %, and the amount of Si may be 0 to 7.0 atom %. The amount of Fe is preferably 65 atom % or more. Also, for example, the Fe—Si—B—Nb—Cu based alloy may be composed of 1.0 to 16.0 atom % Si, 1.0 to 15.0 atom % B, 0.50 to 5.0 atom % Nb, 0.50 to 5.0 atom % Cu, and the balance consisting of Fe and impurities. In this case, the amount of Fe is preferably 65 atom % or more.

The shape of the magnetic powder contained in the main body portion 30 is not limited. The magnetic powder may be spherical, elliptical, scaly, or of an irregular shape. The manufacturing method for rendering these shapes is also not limited.

The particle size distribution of the magnetic powder is not limited. The particle size distribution of the magnetic powder can be obtained, for example, by analyzing an image (secondary electron image), which is an image of a cut surface of the main body portion 30 obtained with a scanning electron microscope. For example, the average equivalent circular diameter of the magnetic powder may be 0.50 to 50.0 μm. The distribution of the equivalent circular diameter may include multiple peaks.

The magnetic powder may be subjected to a surface insulating treatment. Provided that the magnetic powder is subjected to a surface insulating treatment, the insulation resistance of the main body portion 30 is improved. There is no limitation on the type of surface insulating treatment applied to the magnetic powder. Examples include phosphoric acid treatment, phosphate treatment, and oxidation treatment. The magnetic powder may have an insulating coating on the surface of the magnetic particles. This insulating coating may contain at least one selected from a group consisting of Si, P, and B, and O (oxygen).

The magnetic powder may be a mixed material in which multiple powder materials are mixed. This magnetic powder is preferably a ferromagnetic material, and more preferably a soft magnetic material.

The main body portion 30 may further include an optional auxiliary material. The optional auxiliary material is, for example, a binder material or a modifier. The binder material bonds particles such as magnetic powder contained in the main body portion 30 together. This binder material is preferably an insulating material to impart insulation resistance to the main body portion 30.

The binding component may be an organic material or an inorganic material. The organic material may be a resin material. Examples of the resin material include acrylic resin, silicone resin, epoxy resin, phenol resin, urea resin, melamine resin, and polyester resin. The inorganic material may be a glass-based material such as water glass. The binding material may be a product of a reaction such as thermal decomposition, or may be a mixture of multiple materials.

The modifier, for example, improves the mobility of the powder or adjusts the curing speed of the binder material. The modifier may be a glass-based material.

The dimension of the main body portion 30 is not limited. For example, the maximum dimension of the main body portion 30 may be 3.2 mm or less.

### (External Electrode)

As shown in FIG. 2, the outermost (X2 side in X1-X2 direction) end face (first lead conductor end face 14E) of the first lead conductor part 14 and the outermost (X1 side in X1-X2 direction) end face (second lead conductor end face 24E) of the second lead conductor part 24, which are located at the ends of coil member 10, are exposed from the main body portion 30 on the side faces of the main body portion 30 aligned in the X1-X2 direction. A first external electrode 41 is disposed to be in electric contact with the first lead conductor end face 14E, and a second external electrode 42 is disposed to be in electric contact with the second lead conductor end face 24E.

The first external electrode 41 has a side portion 41a that covers the side surface of the main body portion 30 on the X2 side in the X1-X2 direction, and a bottom portion 41b that is provided to cover a portion of the bottom surface (surface on Z2 side in Z1-Z2 direction) of the main body portion 30. The bottom portion 41b is the portion that faces the board when in use. The second external electrode 42 has a side portion 42a that covers the side surface of the main body portion 30 on the X1 side in the X1-X2 direction, and a bottom portion 42b that is disposed on the bottom surface of the main body portion 30 so as to cover a portion of the bottom surface while being spaced apart from the bottom portion 41b. The bottom portion 42b is also the portion that faces the board when in use.

The positions of the first external electrode 41 and the second external electrode 42 are not limited to the above positions. The first external electrode 41 and the second external electrode 42 may be formed to cover a portion of the upper surface (surface on Z1 side in Z1-Z2 direction) of the main body portion 30. Alternatively, the first external electrode 41 and the second external electrode 42 may be disposed only on a portion of the bottom surface (surface on Z2 side in Z1-Z2 direction) of the main body portion 30. In this case, the coil conductor portion 20 may have connecting conductor parts (not shown), which connect two ends of the coil member 10 (the first lead conductor part 14, the second lead conductor part 24) to the bottom surface of the main body portion 30 through the inside of the main body portion 30. In this case, the two ends of the coil member 10 (the first lead conductor end face 14E, the second lead conductor end face 24E) may not be exposed to the side surfaces of the main body portion 30, and the connecting conductor parts may be exposed to the bottom surface of the main body portion 30.

The material and configuration of the first external electrode 41 and the second external electrode 42 are not limited as long as they have appropriate conductivity. One non-limiting example of the first external electrode 41 and the second external electrode 42 is a layer having a structure of Cu plating/Ni plating/Sn plating from the side proximal to the surface of the main body portion 30. The first external electrode 41 and the second external electrode 42 may be composed of a coated electrode, in which a conductive material such as silver is dispersed in a resin or the like. The first external electrode 41 and the second external electrode 42 may also be a combination of plated layer and coated electrode.

### (Outer Cover)

The upper surface of the main body portion 30 (surface on Z1 side in Z1-Z2 direction) and the side surfaces in the Y1-Y2 direction are each provided with an insulating outer cover 50, 60. An insulating outer cover may also be provided on a portion of the bottom surface of the main body portion 30, where the bottom portion 41b of the first terminal member and the bottom portion 42b of the second terminal member are not provided. Furthermore, the coil component 100 may not be provided with the outer covers 50 and 60. The outer covers 50 and 60 can be formed at any position on the surface of the main body portion 30 depending on purposes.

### (Manufacturing Method)

The method for manufacturing the coil component according to the present embodiment is not particularly limited. As a non-limiting example of such a manufacturing method, the method may include forming the first conductor portion 11A and the third conductor portion 14A by electroplating (electrolytic plating).

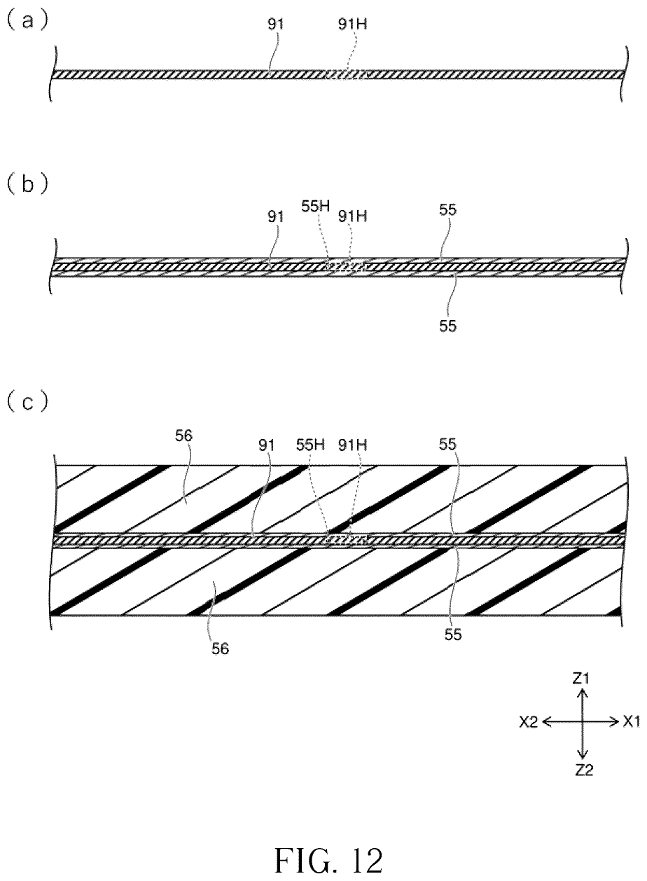

FIG. 12 to FIG. 20 are explanatory schemes (Part 1 to Part 9) illustrating an example of a method for manufacturing a coil component according to an embodiment of the present invention. The method for manufacturing the coil component 100 includes a pattern forming step, a first plating step, and a second plating step for forming the coil member 10. In a preferred embodiment, the method may further include a stripping step, a removal step, and a coating step.

### (a) Preparation of Sheet Substrate

First, as shown in FIG. 12(a), a sheet substrate 91 having a substrate through hole 91H at a position corresponding to the via member VP is prepared. The material of the sheet substrate 91 is not particularly limited as long as it possesses mechanical properties sufficient to function as a support during the formation of the first spiral conductor portion 11 and the second spiral conductor portion 21. Preferably, the sheet substrate 91 has appropriate insulating properties required as a raw material for the first insulator portion 90. In cases where a removal step is performed, it is preferable that at least a part of the sheet substrate 91 exhibits suitable removability.

The thickness of the sheet substrate 91 is set in consideration of its ability to function as a support during the formation of the first and second spiral conductor portions, and, if necessary, the insulating properties of the first insulator portion 90 derived from the sheet substrate 91 and the removability of the sheet substrate 91. As a non-limiting example, the thickness of the sheet substrate 91 may be set to 0.4 μm or more and 20 μm or less. More preferably, the thickness may be 1.0 μm or more, or 5.0 μm or more. To further reduce the size of the coil component 100, the thickness may be 14.0 μm or less.

Examples of the material for forming the sheet substrate 91 include organic materials, inorganic materials, and composite materials thereof. Specific examples of organic materials include thermoplastic resins such as polyimide resin and polyethylene resin, thermosetting resins such as epoxy resin and phenolic resin, and cellulose. Specific examples of inorganic materials include oxide-based materials such as glass and alumina, metal-based materials such as aluminum and magnesium, and inorganic salt-based materials such as calcium carbonate. A specific example of a composite material includes a structure in which an inorganic powder is dispersed in an organic material matrix.

### (b) Formation of Conductive Layer

In the pattern forming step, a pattern 11CP of a conductive layer 11C corresponding to the first conductor portion 11A is formed on the surface of one side (Z1 side in Z1-Z2 direction) of the prepared sheet substrate 91. Meanwhile, a pattern 21CP of a conductive layer 21C corresponding to the first conductor portion 21A is formed on the surface of another side (Z2 side in Z1-Z2 direction).

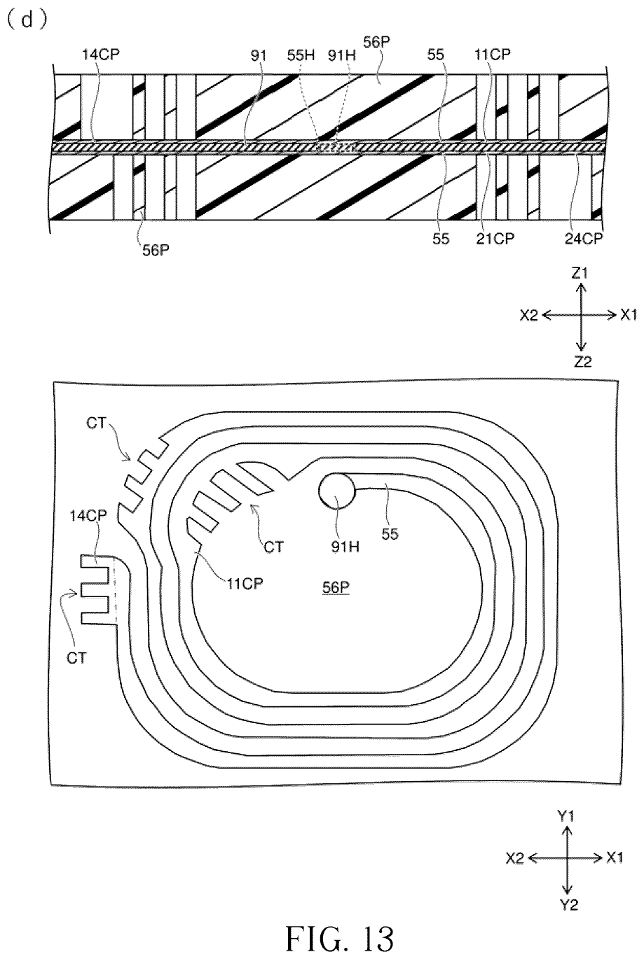

The method for forming the conductive layer patterns 11CP and 21CP is not particularly limited. For example, the method shown in FIG. 12(b) to FIG. 13 may be employed. First, as shown in FIG. 12(b), conductive layers 55 formed of the same material as the conductive layer 11C and the conductive layer 21C are formed on both surfaces of the sheet substrate 91 (both sides in Z1-Z2 direction). The method for forming the conductive layers 55 is not limited and may include a dry process such as sputtering or a wet process such as electroless plating. From the perspective of reducing the thickness of the conductive layers 55, it is preferable that the conductive layers 55 are formed by sputtering.

In this example, as shown in FIG. 12(b), a conductive layer 55H is also formed on the inner surface of the substrate through hole 91H. A member such as a copper-clad laminate having conductive layers 55 pre-formed on both surfaces of the sheet substrate 91 may be prepared. The substrate through-hole 91H may be formed therein. In this case, the inner surface of the substrate through-hole 91H may expose the material of the sheet substrate 91, or a separate process for forming the conductive layer 55H may be performed.

### (c) Formation of Insulating Layer

Next, as shown in FIG. 12(c), insulating layers 56 made of a material subject to patterning, such as dry film resist, are laminated on the conductive layers 55 provided on both surfaces of the sheet substrate 91. The thickness of each insulating layer 56 is formed to be greater than the thickness of the first conductor portion 11A and also greater than the thickness of the first conductor portion 21A, thereby improving the shape controllability of the conductor the first conductor portion 11A and the first conductor portion 21A.

### (d) Formation of Conductive Layer Pattern

Subsequently, exposure and development processes are performed on the insulating layers 56 on both sides in the Z1-Z2 direction to remove portions of the insulating layers 56 and form negative patterns 56P having inverted shapes respectively corresponding to the conductive layer pattern 11CP corresponding to the first conductor portion 11A and the conductive layer pattern 21CP corresponding to the first conductor portion 21A. As a result, portions of the conductive layers 55 are exposed, and the conductive layer pattern 11CP and the conductive layer pattern 21CP are formed as shown in FIG. 13.

As shown in the XY plan view of FIG. 13, the conductive layer pattern 11CP of the conductive layer 11C includes a comb-shaped structure CT in a region corresponding to the turn-widened section 11W of the first spiral conductor portion 11. The shape of the conductive layer pattern 11CP corresponds to the shape of the first conductor portion 11A. The conductive layer pattern 14CP of the conductive layer 11C also has a shape corresponding to the shape of the third conductor portion 14A and includes a comb-shaped structure CT.

During the exposure and development of the insulating layers 56 on both sides in the Z1-Z2 direction, portions corresponding to the conductive layer 14C having the lead conductor part 14 and the conductive layer 24C having the lead conductor part 24 are removed. As a result, the negative pattern 56P on the Z1 side can form the conductive layer pattern 14CP, and the negative pattern 56P on the Z2 side can form the conductive layer pattern 24CP.

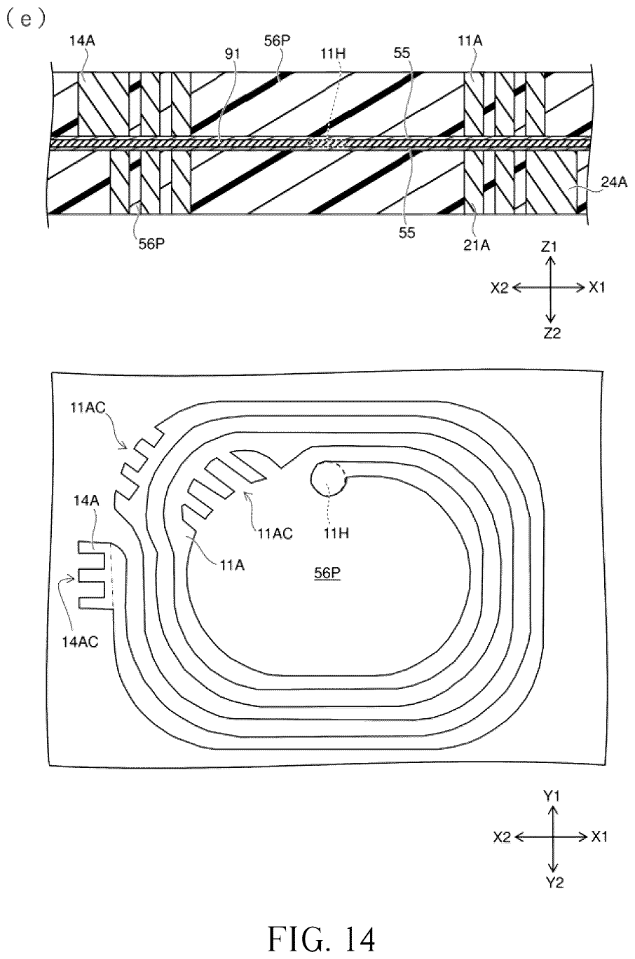

Accordingly, as shown in FIG. 14, the conductive layer pattern 14CP of the conductive layer 11C corresponding to the third conductor portion 14A is continuously formed with the conductive layer pattern 11CP of the conductive layer 11C corresponding to the first conductor portion 11A. Meanwhile, the conductive layer pattern 24CP of the conductive layer 24C corresponding to the third conductor portion 24A is continuously formed with the conductive layer pattern 21CP of the conductive layer 21C corresponding to the first conductor portion 21A.

### (e) Formation of First Conductor Portion

Once the conductive layer pattern 11CP of the conductive layer 11C as well as the conductive layer pattern 14CP of the conductive layer 14C, and the conductive layer pattern 21CP of the conductive layer 21C as well as the conductive layer pattern 24CP of the conductive layer 24C are formed, the first plating step is performed. In the first plating step, by applying electric current to the conductive layers 55 disposed on both sides of the sheet substrate 91 to conduct electroplating, the first conductor portion 11A and the third conductor portion 14A, as well as the first conductor portion 21A and the third conductor portion 24A, are formed on the conductive layer patterns.

As shown in the XY plan view of FIG. 14, the first conductor portion 11A, corresponding to the comb-shaped structure CT of the conductive layer pattern 11CP, includes a rugged portion 11AC having a shape different from other portions. The third conductor portion 14A also includes a rugged portion 14AC, corresponding to the comb-shaped structure CT of the conductive layer pattern 14CP.

In the pattern forming step, since the negative pattern 56P formed from the insulating layer 56 is disposed around the periphery of the conductive layer patterns, in the first plating step, electroplating is performed using the negative pattern 56P as a masking material. As a result, the first conductor portion 11A and the third conductor portion 14A are integrally formed, and the first conductor portion 21A and the third conductor portion 24A are integrally formed corresponding to the conductive layer patterns 21CP and 24CP, corresponding to the conductive layer patterns 11CP, 14CP, 21CP, and 24CP. In addition, in the first plating step, a via conductor portion 11H is formed so as to fill the substrate through-hole 91H. Since this via conductor portion 11H forms the via member VP, the via member VP is integrally formed with both the first spiral conductor portion 11 and the second spiral conductor portion 21 in the first plating step.

The plating deposit formed by electroplating is not particularly limited as long as it has appropriate conductivity. As described above, materials containing Cu, such as Cu or Cu alloys, are non-limiting examples.

Here, when electroplating is performed under a condition that the negative pattern 56P is disposed around the periphery of the conductive layer pattern, the exposed area of the conductive layer pattern may affect the plating process. In this plating process, plating deposits are formed from metal ions contained in the plating solution on the surface of the conductive layer 55. For the formation of plating deposits, it is necessary to supply metal ions and electrons to the surface of the conductive layer 55. When plating deposits are precipitated, the concentration of metal ions near the surface of the conductive layer 55 decreases, and a concentration gradient of metal ions is generated between the vicinity of the surface of the conductive layer 55 and the offshore region of the plating solution. The metal ions are supplied to the vicinity of the surface of the conductive layer 55 by diffusion, which is driven by this concentration gradient, and electrons are rapidly supplied to the vicinity of the surface of the conductive layer 55 by energization, thereby continuing the formation of plating deposits. In addition to diffusion, the flow of the plating solution also supplies metal ions to the vicinity of the surface of the conductive layer 55. In a region where the exposed area is narrow, the space above the conductive layer 55 clamped by the negative pattern 56P is narrow, and the negative pattern 56P may obstruct the flow of the plating solution or restrict the direction of diffusion of metal ions contained in the plating solution. Therefore, in the region with narrow exposed area, the supply of metal ions to the surface of the conductive layer 55 tends to be hindered, and the formation rate of plating deposits tends to be lower than a region with wider exposed area.

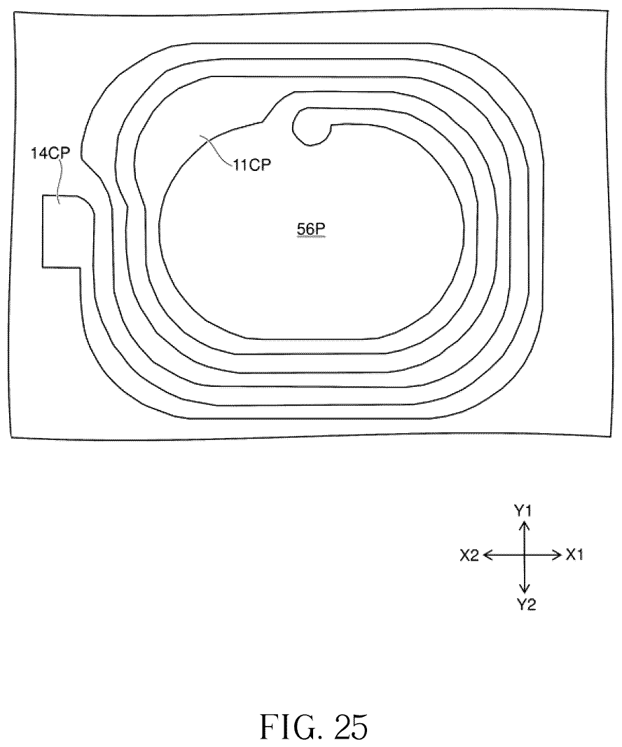

To explain this point specifically, in a case that the pattern has a spiral shape and is narrower in the width direction than in the spiral direction, like the conductive layer pattern 11CP of the conductive layer 11C shown in the XY plan view of FIG. 13, the formation rate of plating deposits may differ between a wider length region and a narrower length region in the width direction. For example, as shown in FIG. 25, when the conductive layer pattern 11CP of the conductive layer 11C has a shape substantially similar to the first spiral conductor portion 11, the turn width Wt in the region corresponding to the turn-widened section 11W of the first spiral conductor portion 11 (see FIG. 3) is relatively large. Therefore, in this region, the formation rate of plating deposits tends to be higher than in other regions, and the thickness of the plating deposits tends to be greater. As a result, variation in the thickness of the first conductor portion 11A may occur, which may lead to quality variation in the coil component 100.

In contrast, in the conductive layer pattern 11CP of the conductive layer 11C shown in the XY plan view of FIG. 13, since the comb-shaped structure CT is formed in the region corresponding to the turn-widened section 11W (see FIG. 3) so that the first conductor portion 11A satisfies the above formula (1), variation in the formation rate of plating deposits is less likely to occur. Therefore, the uniformity of thickness of the first conductor portion 11A is improved, and the quality stability of the coil component 100 can be enhanced.

### (f) Removal of Negative Pattern

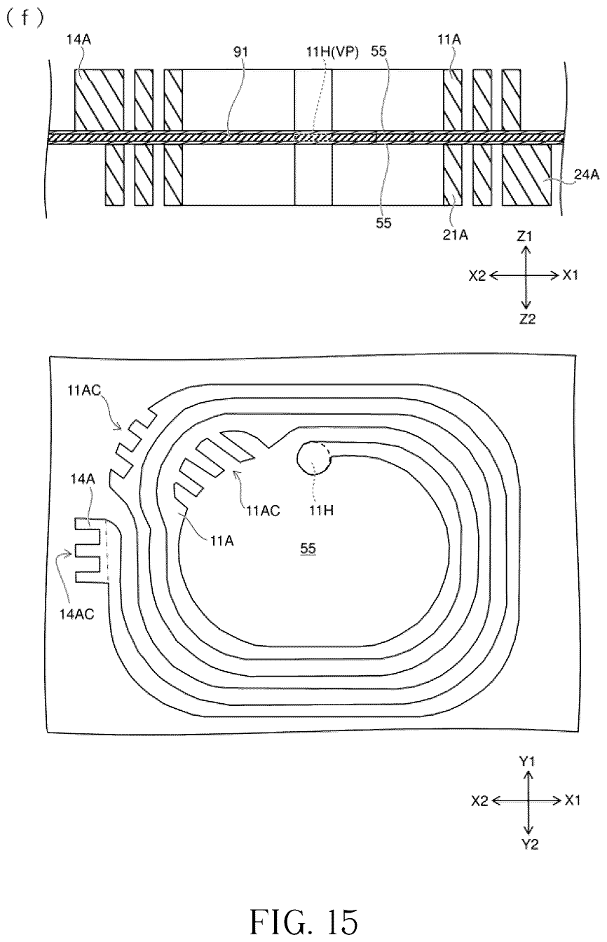

As such, after the first conductor portions 11A and 21A and the third conductor portions 14A and 24A are formed on both sides of the sheet substrate 91, a stripping step is performed to remove the negative pattern 56P formed from the insulating layer 56. As a result, as shown in FIG. 15, a specific structure is obtained in the sheet substrate 91, wherein the conductive layer 55 is positioned on the entire surface except for the substrate through hole 91H, and the first conductor portions 11A and 21A and the third conductor portions 14A and 24A are disposed on the conductive layer 55. As described above, the first conductor portion 11A and the first conductor portion 21A are electrically connected via the via conductor portion 11H, which forms the via member VP.

### (g) Removal of Conductive Layer

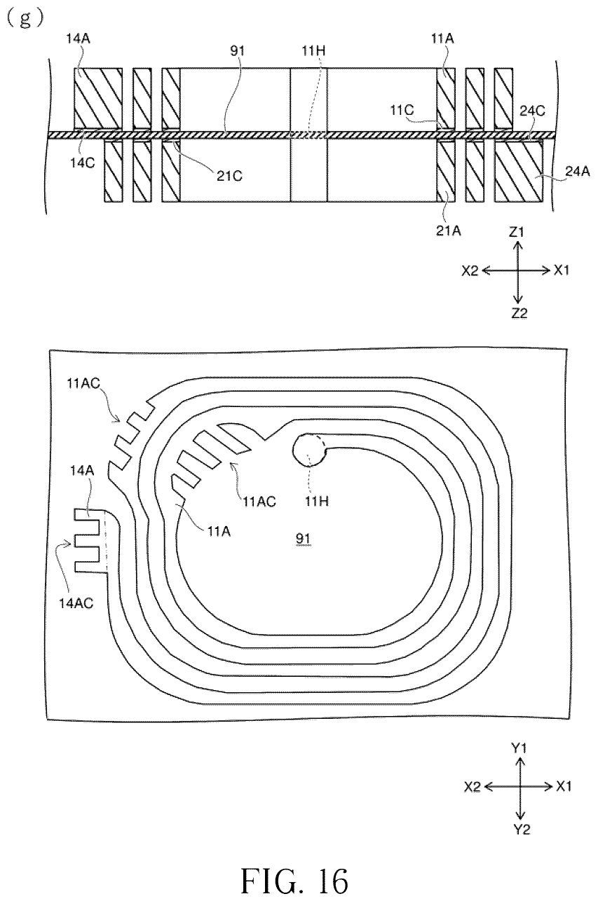

Subsequently, as part of the stripping step, the portion of the conductive layer 55 on the sheet substrate 91, which is exposed in the first direction (Z1-Z2 direction), specifically, the portion not covered by the first conductor portions 11A, 21A and the third conductor portions 14A, 24A, are removed. Accordingly, as shown in FIG. 16, the remaining conductive layer 55 on the sheet substrate 91 becomes the conductive layers 11C, 14C, 21C, and 24C, which are the components forming the coil member 10.

The method for removing the conductive layer 55 is not particularly limited. Any process capable of removing the material constituting the conductive layer 55 with minimal impact on the first conductor portions 11A, 21A and the third conductor portions 14A, 24A may be appropriately selected. For example, when the first conductor portions 11A, 21A and the third conductor portions 14A, 24A are composed of Cu and the conductive layer 55 is composed of Ni, the portion of the conductive layer 55 not covered by the first conductor portions 11A, 21A and the third conductor portions 14A, 24A can be etched with high selectivity. In a case that the material of the conductive layer 55 is the same as that of the first conductor portions 11A, 21A and the third conductor portions 14A, 24A, by way of a process capable of removing the material of the conductive layer 55, the first conductor portions 11A, 21A and the third conductor portions 14A, 24A may also be partially removed. However, in this case, the shape of the plating deposit formed in the first plating step may be designed to account for the amount removed.

### (h) Formation of Second Conductor Portion

By removing the conductive layer 55 as described above, the conductive members exposed on the sheet substrate 91 are substantially limited to the first conductor portions 11A, 21A and the third conductor portions 14A, 24A. In this condition, plating is performed as the second plating step, thereby forming second conductor portions 11B, 21B on the surfaces of the first conductor portions 11A, 21A, and fourth conductor portions 14B, 24B on the surfaces of the third conductor portions 14A, 24A. The plating process in the second plating step may be either electroplating (electrolytic plating) or electroless plating.

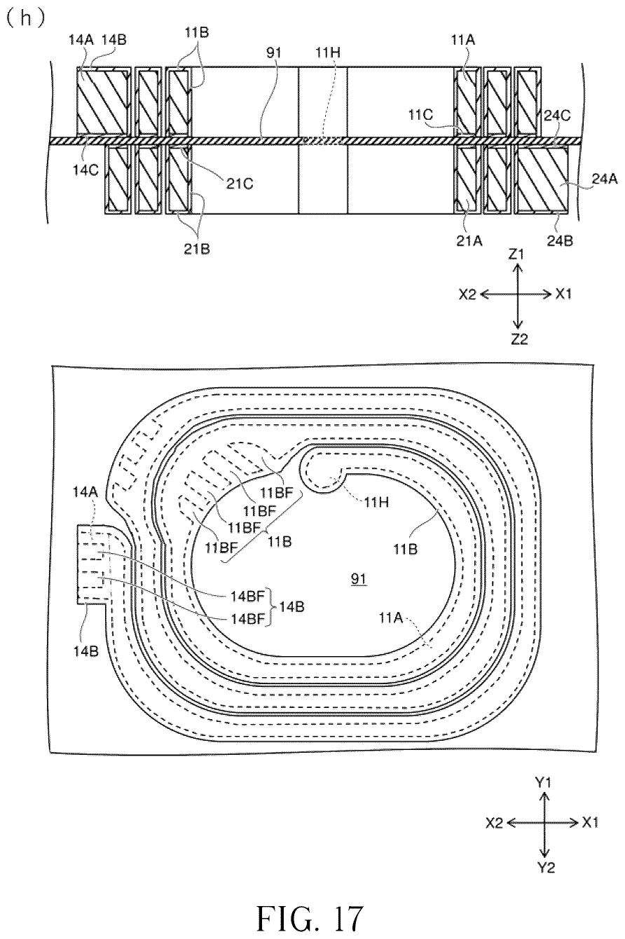

As a result of the plating process, as shown in FIG. 17, the second conductor portions 11B, 21B are provided around the first conductor portions 11A, 21A, and the gaps between the comb teeth of the first conductor portions 11A, 21A are filled with the second conductor portions 11B, 21B to form the filler member 11BF. Similarly, the fourth conductor portions 14B, 24B are provided around the third conductor portions 14A, 24A, and the gaps of the third conductor portions 14A, 24A are filled with the fourth conductor portions 14B, 24B to form the lead filler member 14BF.

### (i) Removal of Sheet Substrate

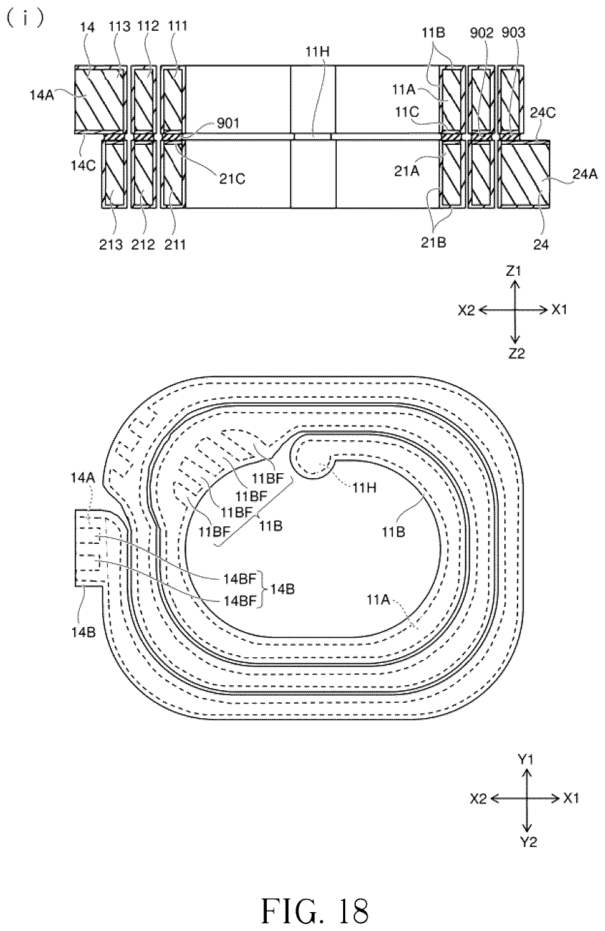

Subsequently, a removal step is performed to remove the exposed portion of the sheet substrate 91 where no conductive members are disposed. Specifically, as shown in FIG. 18, the sheet substrate 91 including the region of the sheet substrate 91, which is enclosed by the inner edge of the first spiral conductor portion 11 when viewed in the first direction (Z1-Z2 direction), is removed. In FIG. 18, the portion between the first inner peripheral turn 111 and the second inner peripheral turn 211, the portion between the first central turn 112 and the second central turn 212, and the portion between the first outer peripheral turn 113 and the second outer peripheral turn 213 of the sheet substrate 91 remain after removal, and become the first insulator portions 901, 902, and 903, respectively.

The specific removal process for the sheet substrate 91 is appropriately set according to the material forming the sheet substrate 91. The removal process is broadly classified into dry processes such as plasma etching and wet processes such as wet etching. From the perspective of preventing the sheet substrate 91 from remaining in, for example, the region enclosed by the inner edge of the first spiral conductor portion 11 and appropriately forming the non-contact portions EP shown in FIG. 10, an isotropic removal process such as wet etching is preferable. Also, from the perspective of improving the removal efficiency of the sheet substrate 91, a wet process may be more preferable. Even if a part of the sheet substrate 91 remains after the removal process, it is acceptable. For example, when the sheet substrate 91 is composed of a composite material of organic and inorganic materials, only the organic material may be removed in the removal process.

### (j) Formation of Second Insulator Portion

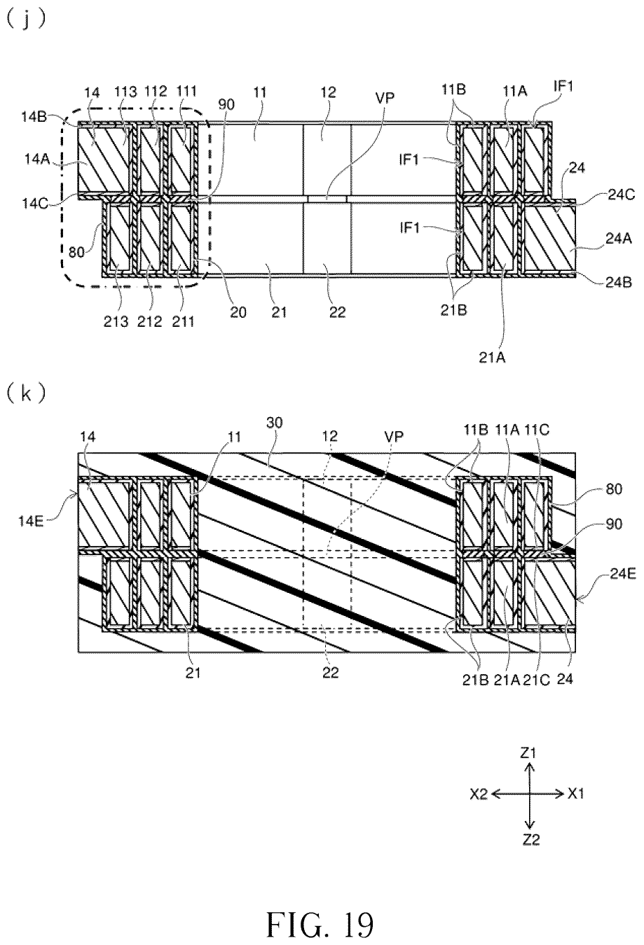

Accordingly, after the sheet substrate 91 is removed, a second insulator portion 80 formed of an insulating material is formed so as to cover at least a part of the exposed portion of the coil conductor portion 20. In FIG. 19, the second insulator portion 80 is provided on the exposed surfaces of the first spiral conductor portion 11 and the second spiral conductor portion 21, which constitute the coil conductor portion 20, as well as on the exposed surfaces of the first lead conductor part 14 and the second lead conductor part 24, excluding the surfaces facing the X1-X2 direction. On the surfaces where the second insulator portion 80 is not formed, external electrodes (first external electrode 41 and second external electrode 42) are provided.

The process for forming the second insulator portion 80 is appropriately set according to the material forming the second insulator portion 80. For example, when the second insulator portion 80 is made of a parylene-based polymer, it is formed by a dry process (CVD). When the second insulator portion 80 includes a curable resin material such as epoxy resin, it may be formed by attaching a powder or liquid containing the material of the second insulator portion 80 to the exposed surfaces, and then solidifying the attached material by, for example, heating.

### (k) Formation of Main Body Portion

After the coil member 10 is formed through the above steps, the next step, as shown in FIG. 19, is to form the main body portion 30 by sealing a part of the first lead conductor part 14 and the second lead conductor part 24 of the coil member 10, while excluding the first lead conductor end face 14E and the second lead conductor end face 24E in a specific example of the present embodiment, with a material containing magnetic powder. The method for forming the main body portion 30 is not particularly limited, and a molding process is exemplified. Specific examples of the molding process include placing the product obtained in step (j) into a mold and forming the main body portion by compression molding using a material containing the magnetic powder, or transfer molding using a material containing the magnetic powder or a precursor thereof. In a case that the product obtained in step (j) is placed into a mold and compression molded to obtain the product of step (k), it is preferable, from the perspective of improving molding quality (quality of product in step (k), for example, specifically uniformity of thickness), it is preferable that the uniformity of the thickness (height in first direction) of the spiral conductor portions (first spiral conductor portion 11 and second spiral conductor portion 21) in the coil member 10 is enhanced. Therefore, as described above, by appropriately providing the filler members 11BF and 21BF in the turn-widened sections 11W and 21W, the thickness uniformity of the first spiral conductor portion 11 and the second spiral conductor portion 21 can be improved, and the molding quality can be enhanced.

The method for forming the main body portion 30 such that the first lead conductor end face 14E and the second lead conductor end face 24E are exposed from the main body portion 30 is not particularly limited. For example, the first lead conductor end face 14E and the second lead conductor end face 24E may be masked prior to forming the main body portion 30. Alternatively, dummy members may be continuously provided so as to cover or be integrally connected to the first lead conductor end face 14E and the second lead conductor end face 24E. The second insulator portion 80 may be formed on the surface of the dummy members, and then the main body portion 30 may be formed. Afterward, the dummy members may be cut to expose the first lead conductor end face 14E and the second lead conductor end face 24E.

### (l) Formation of Outer Cover

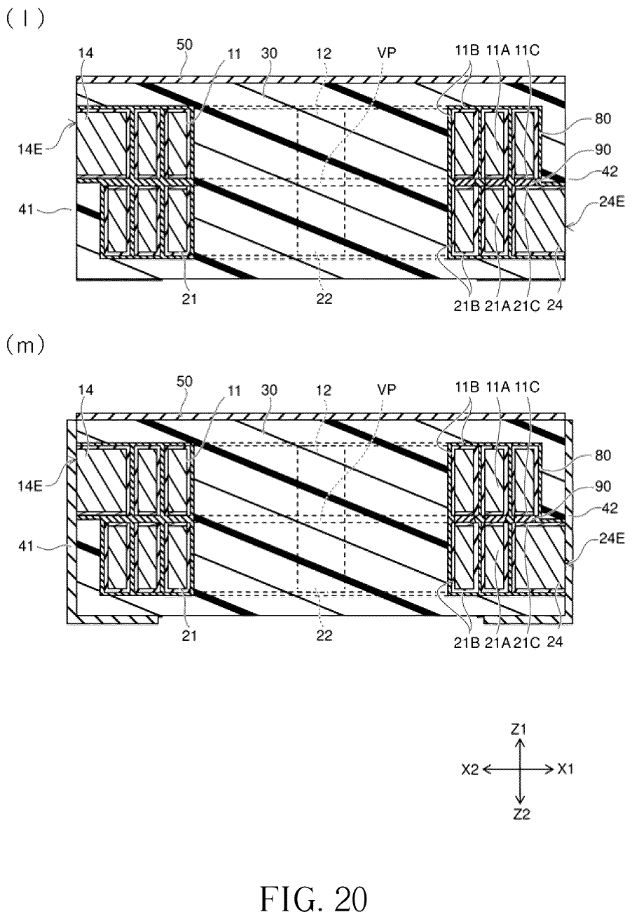

Next, as shown in FIG. 20, an outer cover 50 is applied to a part of the exposed portion of the main body portion 30, specifically, the upper surface of the main body portion 30 (Z1 side in Z1-Z2 direction), to protect the main body portion 30. The main body portion 30 may be left as it originally is. However, the insulating coating on the surface of the magnetic powder forming the main body portion 30 might be scraped off when encountering an external force resulting from collision with another member. Then, a decrease in surface resistance of the main body portion 30 would be caused. Since deterioration of surface insulation may lead to reduced reliability of the coil component 100, it is preferable to provide the outer cover 50 made of an insulating material. The method for forming the outer cover 50 is not particularly limited, and known methods such as printing or coating may be employed. The material forming the outer cover 50 may be a known material such as epoxy resin. From the perspective of improving impact resistance, a composite material in which an inorganic material such as glass fiber is dispersed in an organic material such as epoxy resin may be preferable. In addition to improving insulation reliability and impact resistance, the outer cover 50 may also be formed to improve appearance quality and enhance positioning accuracy of the external electrodes formed in the next step (preventing plating overflow). This step (l) may be repeated multiple times, and in such cases, the outer cover 60 may be formed through step (l).

### (m) Formation of External Electrodes

Finally, one of the two terminal members (first external electrode 41) is electrically connected to a part of the first lead conductor part 14 (first lead conductor end face 14E), which is not sealed with the material containing the magnetic powder during formation of the main body portion 30, and the other of the two terminal members (second external electrode 42) is electrically connected to a part of the second lead conductor part 24 (second lead conductor end face 24E). The method for forming the first external electrode 41 and the second external electrode 42 is not particularly limited, and plating or printing processes are exemplified. In FIG. 20, the first external electrode 41 and the second external electrode 42 are formed so as to extend not only on the side surfaces of the main body portion 30 (surfaces facing X1-X2 direction) but also on a part of the bottom surface of the main body portion 30 (Z2 side in Z1-Z2 direction). As described above, by forming the outer cover 50 prior to forming the external electrodes (first external electrode 41 and second external electrode 42), it is possible to prevent plating deposits from forming on unintended areas of the exposed surface of the main body portion 30, which could otherwise lead to reduced shape accuracy of the external electrodes or increased risk of short-circuiting of the external electrodes (plating overflow). From this perspective, it may be preferable that the outer cover 50 is also formed on the bottom surface (Z2 side in Z1-Z2 direction), which serves as the mounting surface.

### (Modified Example of First Conductive Layer)

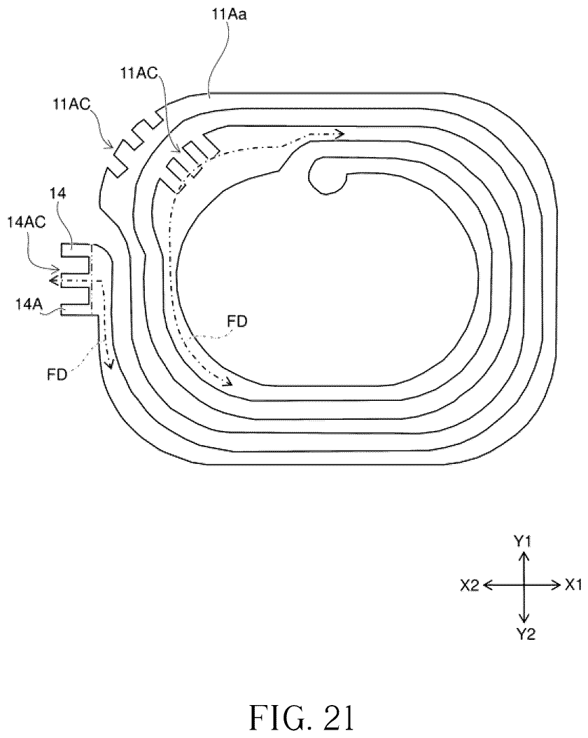

FIG. 21 to FIG. 24 are XY plan views illustrating other examples (first one to fourth one) of the first conductor portion included in the coil member of the coil component according to an embodiment of the present invention.

The first conductor portion 11Aa shown in FIG. 21 differs from the aforementioned first conductor portion 11A in the shape of the rugged portion 11AC. Specifically, the rugged portion 11AC in the inner turn has a comb-shaped structure that opens outward.

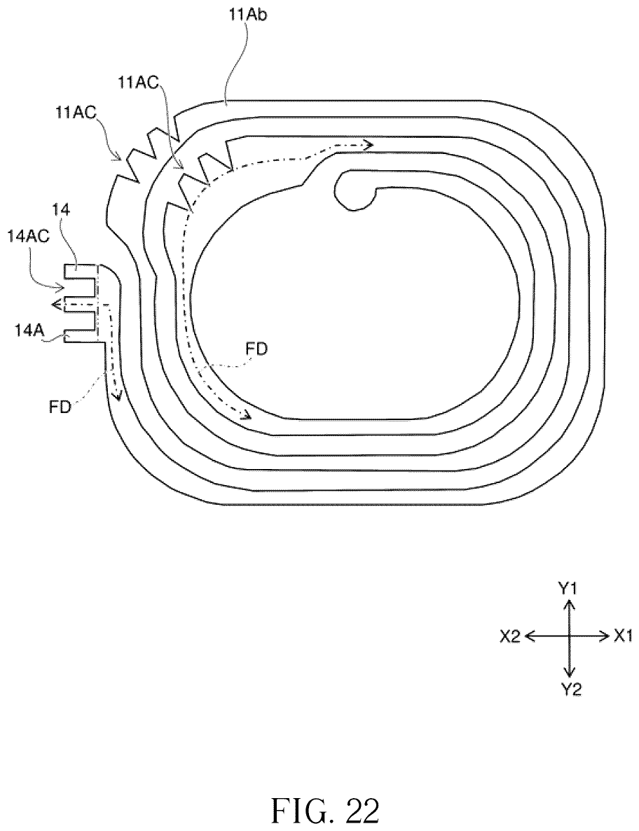

The first conductor portion 11Ab shown in FIG. 22 differs from the aforementioned first conductor portion 11A in the shape of the rugged portion 11AC. Specifically, in the first conductor portion 11A, the rugged portion 11AC is formed by substantially rectangular notches, whereas in the first conductor portion 11Ab, the uneven portion 11AC is formed by substantially triangular notches.

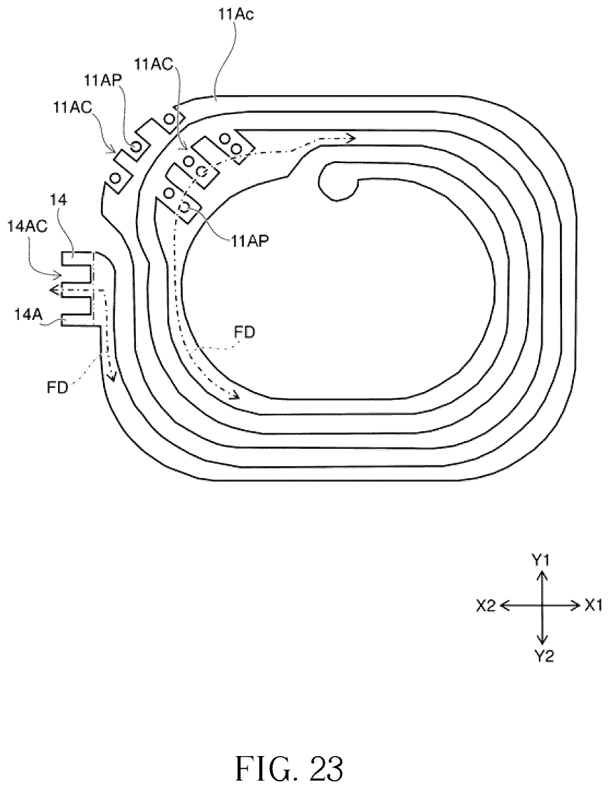

The first conductor portion 11Ac shown in FIG. 23 differs from the aforementioned first conductor portion 11A not only in the shape of the rugged portion 11AC but also in that a pillar portion 11AP is provided. Specifically, in the first conductor portion 11A, the rugged portion 11AC is formed by substantially rectangular notches, and no portion made of the first conductive material is present in the notched area. In contrast, in the first conductor portion 11Ac, a pillar portion 11AP made of the first conductive material and having a substantially circular outer shape when viewed from the first direction is disposed in the notched area. Furthermore, similar to the first conductor portion 11Aa, the rugged portion 11AC in the inner turn has a comb-shaped structure that opens outward, which also differs from the first conductor portion 11A.

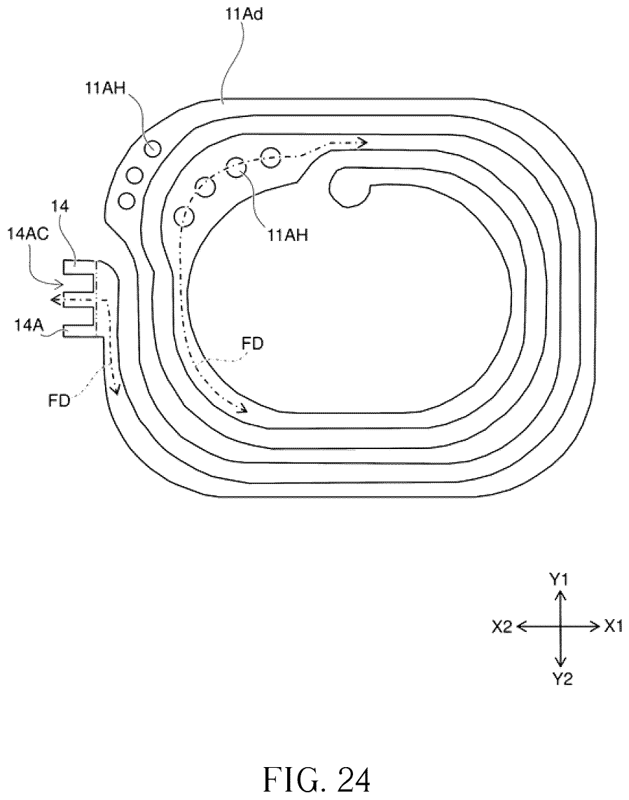

The first conductor portion 11Ad shown in FIG. 24 differs from the aforementioned first conductor portion 11A in that, instead of the rugged portion 11AC having a comb-shaped structure, a plurality of through holes 11AH are provided.

### (Electronic/Electric Device)

The electronic/electrical device according to one embodiment of the present invention is an electronic/electric device in which the coil component 100 according to one embodiment of the present invention is installed. The coil component 100 is connected to a board with the first external electrode 41 and the second external electrode 42. The electronic/electric device according to an embodiment of the present invention can be easily miniaturized because it is mounted with the coil component 100 according to an embodiment of the present invention. Furthermore, even if a large current passes through the device or a high frequency is applied, malfunctions caused by deterioration of the function of the coil component 100 or heat generation are unlikely to occur.

The above-described embodiments and examples are described to facilitate understanding of the present invention, and are not described to limit the present invention. Therefore, each element disclosed in the above embodiments and examples is intended to include all design modifications and equivalents that fall within the technical scope of the present invention.

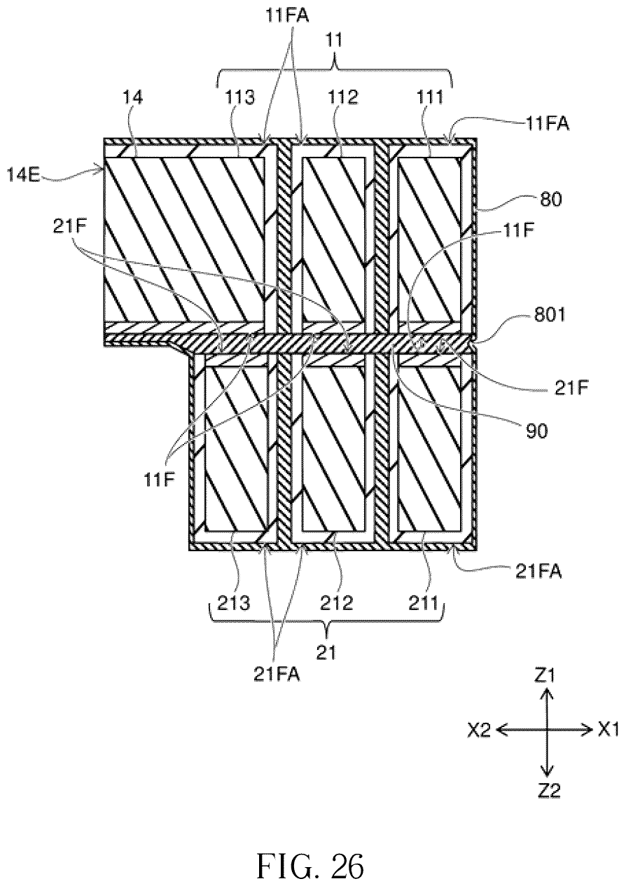

For example, in FIG. 10, the first facing portion 11F and the second facing portion 21F include non-contact parts EP, which is not in contact with the first insulator portion 90. In these non-contact parts EP, the first facing portion 11F and the second facing portion 21F are in contact with the second insulator portion 80. However, this configuration is not limiting. For example, as shown in FIG. 26, which is an XZ cross-sectional view illustrating another example of the coil insulator portion included in the coil component according to an embodiment of the present invention, the first insulator portion 90 may be configured without any non-contact part EP. In the example shown in FIG. 26, the first insulator portion 90 is continuously positioned between the first coil conductor portion 201 and the second coil conductor portion 202 (without interruption between adjacent turns when viewed from the first direction). Furthermore, in the example shown in FIG. 26, the second insulator portion 80 is disposed so as to fill the gaps between adjacent turns (for example, between the first inner peripheral turn 111 and the first central turn 112).

What is claimed is:

1. A coil component, wherein the coil component comprises a coil member, the coil member comprises a coil conductor portion, the coil conductor portion comprises a first spiral conductor portion having a spiral shape when viewed in a first direction, characterized in that the coil conductor portion comprises:
a first conductor portion formed of a first conductive material, which extends in the spiral direction from one end part to another end part of the first spiral conductor portion; and
a second conductor portion formed of a second conductive material, which is electrically connected to the first conductor portion at a first interface along the first direction,
wherein the second conductor portion comprises a filler member on both sides in a second direction orthogonal to the first direction, where the first interfaces are located.

2. The coil component according to claim 1, wherein the filler member is disposed in a region other than a narrowest section of the first spiral conductor portion, where a turn width is the smallest.

3. The coil component according to claim 1, wherein:
the coil component further comprises:
a main body portion, which covers the coil member and contains a magnetic powder; and
a pair of external electrodes, which are in contact with a surface of the coil member exposed from the main body portion and are electrically connected through the coil member, and
the coil conductor portion comprises:
a second spiral conductor portion having a spiral shape facing the first spiral conductor portion in the first direction;
a via member contacting one end part of the first spiral conductor portion and one end part of the second spiral conductor portion, and electrically connecting the first spiral conductor portion and the second spiral conductor portion in the first direction;
a first lead conductor part contacting another end part of the first spiral conductor portion and one of the pair of external electrodes, and electrically connecting the first spiral conductor portion and the one of the pair of external electrodes;
a second lead conductor part contacting another end part of the second spiral conductor portion and the other of the pair of external electrodes, and electrically connecting the second spiral conductor portion and the other of the pair of external electrodes,
wherein the coil member comprises a coil insulator portion in contact with a surface of a part of the coil conductor portion, which is located inside the main body portion in the coil conductor portion.

4. The coil component according to claim 3, wherein:
the first lead conductor part comprises:
a third conductor portion formed of the first conductive material and extending from the first conductor portion in a current flow direction; and
a fourth conductor portion formed of the second conductive material and electrically connected to the third conductor portion at a second interface along the first direction,
wherein the fourth conductor portion comprises a lead filler member on both sides in the second direction orthogonal to the first direction, where the second interfaces are located.

5. The coil component according to claim 3, further comprising a conductive layer at an end part of the first conductor portion on a side facing the second spiral conductor portion in the first direction.

6. The coil component according to claim 3, wherein the second conductor portion extends to the end part of the first conductor portion on a side opposite to the side facing the second spiral conductor portion in the first direction.

7. The coil component according to claim 4, wherein the fourth conductor portion extends to the end part of the first lead conductor portion on a side opposite to the side, where the second spiral conductor portion is located, in the first direction.

8. The coil component according to claim 3, wherein the coil insulator portion comprises a first insulator portion disposed between the first spiral conductor portion and the second spiral conductor portion.

9. The coil component according to claim 3, wherein the coil insulator portion comprises a second insulator portion in contact with at least one of a side surface of a turn of the first spiral conductor portion and a side surface of a turn of the second spiral conductor portion.

10. The coil component according to claim 9, wherein the second insulator portion comprises a first connecting part, which connects a part in contact with the side surface of the turn of the first spiral conductor portion and a part in contact with the side surface of the turn of the second spiral conductor portion.

11. A method for manufacturing a coil component, wherein the coil component comprises a coil component, the coil member comprises a coil conductor portion, and the coil conductor portion comprises a first spiral conductor portion having a spiral shape when viewed in a first direction,
the coil conductor portion comprising a first conductor portion formed of a first conductive material, and a second conductor portion formed of a second conductive material, and
the method for manufacturing the coil component comprising:
a pattern-forming step, forming a conductive layer pattern, which has a shape corresponding to the first conductor portion, on a surface of an insulating sheet substrate;
a first plating step, forming the first conductor portion on the conductive layer pattern by electroplating while applying a current to a conductive layer; and
a second plating step, forming the second conductor portion on a surface of the first conductor portion by plating,
wherein the second conductor portion formed by the second plating step comprises a filler member on both sides in a second direction orthogonal to the first direction, where a first interface is an interface between the first conductor portion and the second conductor portion.

12. The method for manufacturing the coil component according to claim 11, wherein the conductive layer pattern is formed in the pattern-forming step such that the filler member is formed in a region other than a narrowest section of the first spiral conductor portion, where a turn width is the smallest.

13. The method for manufacturing the coil component according to claim 11, wherein in the pattern-forming step, the conductive layer pattern is formed by disposing an insulating negative pattern, which has an inverted shape of the conductive layer pattern, onto the conductive layer, and in the first plating step, electroplating is performed using the negative pattern as a masking material.

14. The method for manufacturing the coil component according to claim 13, further comprising a stripping step between the first plating step and the second plating step for stripping off the negative pattern and removing the conductive layer exposed in the first direction.

15. The method for manufacturing the coil component according to claim 11, wherein:
the coil component further comprises:
a main body portion, which covers the coil member and contains a magnetic powder; and
a pair of external electrodes, which are in contact with a surface of the coil member exposed from the main body portion and are electrically connected through the coil member,
the coil conductor portion further comprises:
a first lead conductor part contacting another end part of the first spiral conductor portion and one of the pair of external electrodes, and electrically connecting the first spiral conductor portion and the one of the pair of external electrodes, the first lead conductor part comprises:
a third conductor portion formed of the first conductive material and extending from the first conductor portion in the current flow direction; and
a fourth conductor portion formed of the second conductive material and electrically connected to the third conductor portion at a second interface along the first direction,
the conductive layer pattern formed in pattern-forming step has a shape corresponding to the third conductor portion,
the third conductor portion is integrally formed with the first conductor portion in the first plating step, and
the fourth conductor portion is formed in the second plating step.

16. The method for manufacturing the coil component according to claim 15, wherein the fourth conductor portion comprises a lead filler member on both sides in the second direction orthogonal to the first direction, where the second interfaces are located.

17. The method for manufacturing the coil component according to claim 11, wherein:
the coil conductor portion comprises:
a second spiral conductor portion having a spiral-shaped turn and arranged in the first direction alongside the first spiral conductor portion; and
a via member in contact with one end part of the first spiral conductor portion and one end part of the second spiral conductor portion, and electrically connecting the first spiral conductor portion and the second spiral conductor portion in the first direction,
the sheet substrate comprises a substrate through hole corresponding to the via member,
in the pattern-forming step, a conductive layer pattern corresponding to the second conductor portion is formed on a surface of the sheet substrate opposite to a surface, where the conductive layer pattern corresponding to the first conductor portion is formed, and
in the first plating step, the first conductive material is provided inside the substrate through hole to form the via member, thereby electrically connecting the first spiral conductor portion and the second spiral conductor portion.

18. The method for manufacturing the coil component according to claim 11, wherein the conductive layer is formed of a material having an etching property different from that of the first conductive material.

19. The method for manufacturing the coil component according to claim 11, wherein the first conductor portion is formed of a material containing Cu.

20. The method for manufacturing the coil component according to claim 11, wherein the second conductor portion is formed of a material containing Cu.

21. The method for manufacturing the coil component according to claim 11, wherein after the second plating step, the method further comprises a removal step for removing a region on the sheet substrate, which is enclosed by an inner edge of the first spiral conductor portion when viewed in the first direction.

22. The method for manufacturing the coil component according to claim 11, wherein after at least the second plating step is completed, the method further comprises a coating step for providing an insulating material to cover at least a portion of an exposed part of the coil conductor portion.
